(19) United States
(12) Patent Application Publication
(10) Pub. No.: US 2017/0046794 A1
(43) Pub. Date: Feb. 16, 2017

(54) SYSTEM FOR SOURCING TALENT UTILIZING CROWDSOURCING

(71) Applicant: Accenture Global Services Limited, Dublin (IE)

(72) Inventors: Arpan SHUKLA, Chennai (IN); Vijayaraghavan KOUSHIK, Chennai (IN); Rajendra T. PRASAD, Bangalore (IN); Suparna MOITRA, Bangalore (IN); Sandeep J. RATHOD, Mumbai (IN); Madhuri VISHNUBHATLA, Bengaluru (IN)

(21) Appl. No.: 14/823,039

(22) Filed: Aug. 11, 2015

(51) Int. Cl. G06Q 50/00; G06Q 10/06

(52) U.S. Cl. CPC G06Q 50/01; G06Q 10/063112

(57) ABSTRACT

A system may obtain a work request eligible for crowdsourcing and determine a work request type associated with the work request. The system may provide the work request to a group of talent devices. The system may assign the work request to one or more users associated with the group of talent devices based on the work request type. The system may obtain one or more deliverables associated with the work request and may validate the one or more deliverables based on the work request type. The system may obtain feedback information for the one or more deliverables. The system may generate a game score based on the feedback information and may provide the feedback information and the game score to one or more talent devices, of the group of talent devices, associated with the one or more users assigned to the work request.

### BACKGROUND

Crowdsourcing is a process of obtaining needed services, ideas, and/or content by soliciting contributions from a large group of people (e.g., an on-line community), rather than from traditional employees or suppliers. Crowdsourcing can involve division of labor, competition, crowdfunding, and/or a general search to obtain the needed services, ideas, and/or content.

### SUMMARY

According to some implementations, a system may include one or more server devices. The one or more server devices may obtain a work request eligible for crowdsourcing. The one or more server devices may determine a work request type associated with the work request. The one or more server devices may provide the work request to a group of talent devices. The one or more server devices may assign the work request to one or more users associated with the group of talent devices based on the work request type. The one or more server devices may obtain one or more deliverables associated with the work request. The one or more server devices may validate the one or more deliverables based on the work request type. The one or more server devices may obtain feedback information for the one or more deliverables after validating the one or more deliverables. The one or more server devices may generate a game score based on the feedback information for the one or more deliverables. The one or more server devices may provide the feedback information and the game score to one or more talent devices, of the group of talent devices, associated with the one or more users assigned to the work request.

According to some implementations, a computer-readable medium may store instructions. The instructions may include a set of instructions that, when executed by one or more processors, may cause the one or more processors to obtain a work request eligible for crowdsourcing from a project management device. The set of instructions, when executed by the one or more processors, may cause the one or more processors to determine a work request type associated with the work request. The work request type may be a first work request type or a second work request type. The set of instructions, when executed by the one or more processors, may cause the one or more processors to provide the work request to a group of talent devices. The set of instructions, when executed by the one or more processors, may cause the one or more processors to assign the work request to one or more users associated with the group of talent devices based on whether the work request type is the first work request type or the second work request type. The work request may be assigned after obtaining approval to assign the work request to the one or more users when the work request type is the first work request type. The work request may be automatically assigned, based on acceptance by the one or more users, when the work request type is the second work request type. The set of instructions, when executed by the one or more processors, may cause the one or more processors to obtain one or more deliverables, associated with the work request, to provide to a project management device. The set of instructions, when executed by the one or more processors, may cause the one or more processors to validate the one or more deliverables. The set of instructions, when executed by the one or more processors, may cause the one or more processors to obtain feedback information for the one or more deliverables after validating the one or more deliverables. The set of instructions, when executed by the one or more processors, may cause the one or more processors to provide the feedback information to one or more talent devices, of the group of talent devices, associated with the one or more users assigned to the work request.

According to some implementations, a method, performed by one or more processors of one or more server devices, may include obtaining a work request eligible for crowdsourcing from a project management device; determining a work request type associated with the work request; providing the work request to a group of talent devices; assigning the work request to one or more users associated with one or more talent devices of the group of talent devices based on the work request type; obtaining, from the one or more talent devices, one or more deliverables, associated with the work request, to provide to the project management device; validating the one or more deliverables; obtaining feedback information for the one or more deliverables after validating the one or more deliverables; generating a game score based on the feedback information for the one or more deliverables; providing the feedback information and the game score to the one or more talent devices; and providing incentives based on the feedback information and/or the game score.

### BRIEF DESCRIPTION OF THE DRAWINGS

FIGS. 1A-1B are diagrams of an overview of an example implementation described herein;

FIG. 2 is a diagram of an example environment in which systems and/or methods, described herein, may be implemented;

FIG. 3 is a diagram of example components of one or more devices of FIG. 2;

FIG. 4 is a flow chart of an example process for using a system for sourcing talent utilizing crowdsourcing;

FIGS. 5A-5Z are diagrams of an example implementation relating to the example process shown in FIG. 4; and

FIGS. 6A-6I are diagrams of another example implementation relating to the example process shown in FIG. 4.

### DETAILED DESCRIPTION

The following detailed description of example implementations refers to the accompanying drawings. The same reference numbers in different drawings may identify the same or similar elements.

A knowledge-based company uses systems and processes to generate, transform, and/or manage knowledge-based products and services to achieve project goals and/or work product. Knowing which individual or talent has the right expertise, experience, availability, and/or interest to work on a particular project may prove challenging. Project timetables, scope, and/or deliverables may change at any time and project managers may not have access to availability and/or interest information for the talent in real-time or near real-time. Also, project managers may not have the latest information on experience and expertise of the talent, as this information may change over time. Similarly, the talent may not have real-time access to available projects and/or incentive to take on additional work.

Implementations described herein provide a system for sourcing talent, utilizing crowdsourcing solutions. Project managers may create and/or post work requests, including work request information, seeking talent to perform work associated with the work requests. Work request information may include an associated project, work request requirements (e.g., objectives for the work request, a scope for the work request, a list of deliverables satisfying the objectives/scope, a list of tasks satisfying the objectives/scope, etc.), a work request type (i.e., chargeable or a challenge), an estimate of hours to perform the work, desired skills for the talent, gaming information, or the like. Work requests may be a challenge work request, allowing multiple talent to accept assignment of the work request without approval from a project manager. Work requests may also be chargeable work requests, where the project managers may assign talent and/or authorize performance of the work, associated with the work request.

The system may be gamified, to incentivize the talent to request assignment to the chargeable work request and/or to accept the challenge work request. A gaming score (e.g., game points awarded for completing the work requests) may be generated, analyzed, and/or utilized for determining ranking information, feedback information (e.g., comments, quantitative ratings, etc.), incentives (e.g., rewards), and/or other uses.

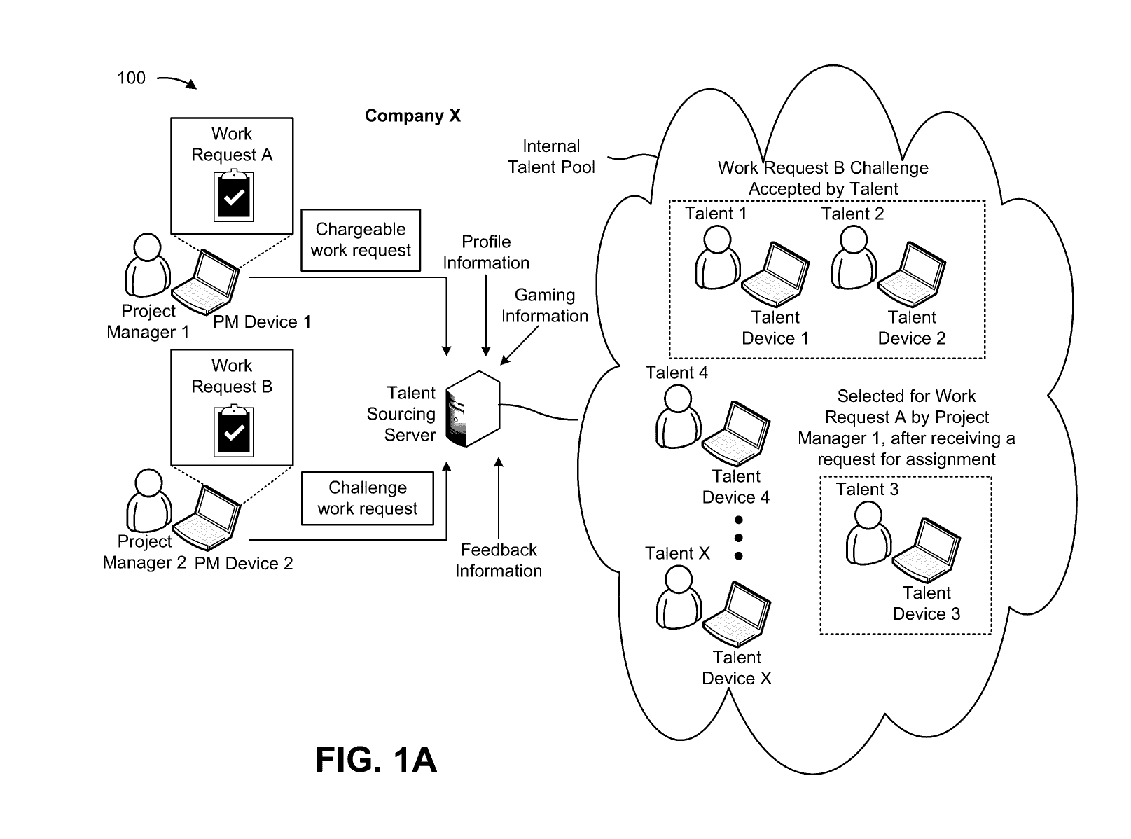

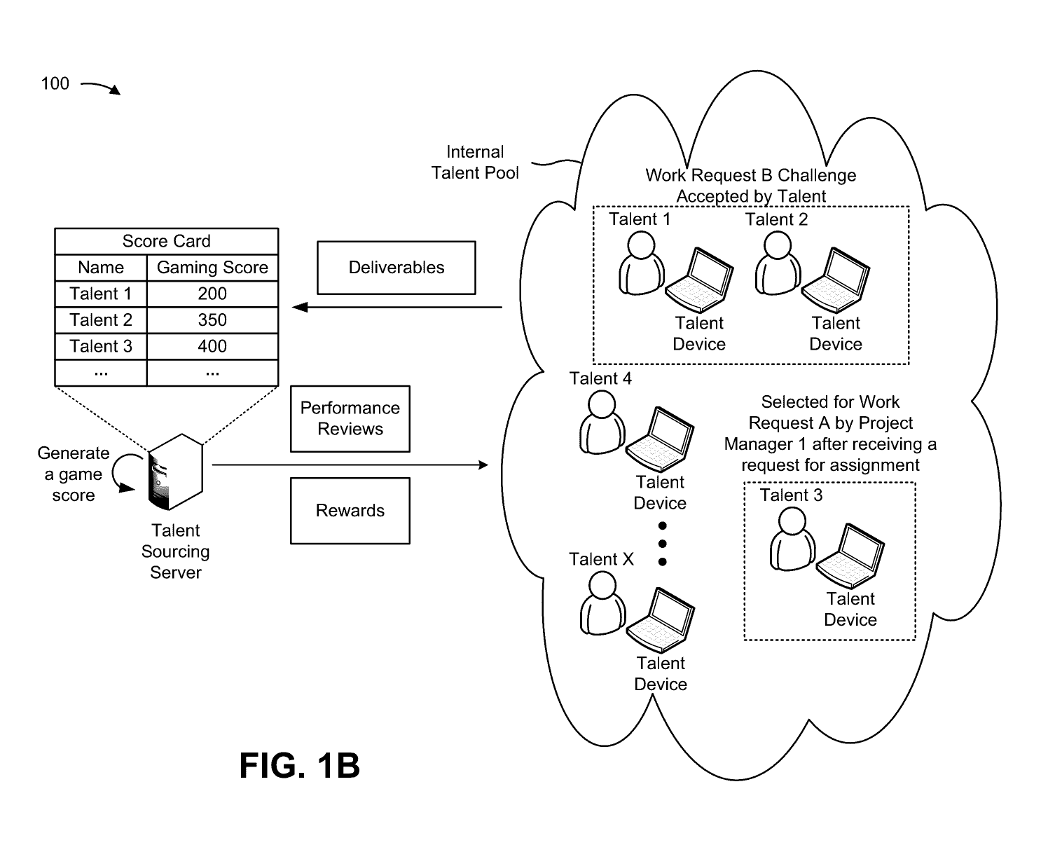

FIGS. 1A-1B are diagrams of an overview of an example implementation 100 described herein. As shown in FIG. 1A, assume that project managers of a knowledge-based company (e.g., Project Manager 1 of Company X, Project Manager 2 of Company X, etc.) have various work requests (e.g., Work Request A, Work Request B, etc.), eligible for crowdsourcing. A work request is a request for work to be performed by talent (e.g., Talent 1, Talent 2, Talent 3, Talent 4, etc.), associated with the company. A work request may be associated with a larger project, made up of one or more work requests. A work request may be chargeable or a challenge.

A chargeable work request is a work request, where the work performed associated with the work request, may be charged/billed to a third-party (e.g. a client) and/or another party. A chargeable work request may include any ad-hoc requests in a project, where the work is not a critical milestone to the project and may be assigned to the talent, without impacting existing project schedules/milestones. The talent may not accept a chargeable work request unilaterally. The talent may submit a request for assignment to the chargeable work request. A project manager may approve the request before the talent may perform work associated with the work request. The project manager may provide a charge code (e.g., a billing code) to the talent for billing time for the work performed associated with the work request.

In contrast, a challenge work request is a work request, where the work performed may be not billed (e.g., additional innovation projects/tasks or ideas developed to enhance and/or increase efficiency of the knowledge-based company). A challenge work request may be provided to multiple talent as a challenge (e.g., all employees, a subset of employees from a particular department, a subset of employees from a particular location, etc.). Multiple talent may accept the challenge work request unilaterally to perform work and/or provide deliverables, associated with the challenge work request. The project manager may select one or more deliverables (e.g., the best deliverable satisfying the challenge work request, the top three deliverables satisfying the challenge work request, the top five deliverables satisfying the challenge work request, etc.).

Work requests eligible for crowdsourcing may correspond to work requests that are not client-sensitive (e.g., providing/presenting the work request and associated information/documentation to a talent, not assigned to a client project associated with the work request, does not violate security framework/rules agreed to with the client). Additionally, work requests eligible for crowdsourcing may correspond to work requests that do not impact project milestones. Additionally, work requests eligible for crowdsourcing may correspond to work requests that permit talent to perform work, associated with the work request, in parallel to other work requests performed by other talent (e.g., work requests that are not critical to starting performance on work associated with other work requests).

Project managers may not unilaterally assign work requests. Rather, talent may proactively search for and select work requests based on various factors (e.g., interest, gaming incentives, availability, etc.).

The work requests may be associated with a gamified system (e.g., an incentive driven system), where the talent may be awarded game points for providing deliverables, associated with the work requests, determined based on various criteria/rules for awarding the game points. The game points may be awarded, for example, based on a measure of quality for the work performed, based on speed and/or efficiency, based on a measure of complexity of the work performed, or the like. The talent may be awarded game points in various areas (e.g., as a contributor, as an achiever, as a time keeper, etc.). A game score, for each of the various areas, may be determined based on combining the game points awarded to the talent for completing one or more work requests.

As shown in FIG. 1A, assume project managers and talent create secure accounts for a talent sourcing application (e.g., using a secure web client), associated with a talent sourcing server (e.g., Talent Sourcing Server). The project managers and the talent may use an interface (e.g., a dashboard) for the talent sourcing application, located on the project managers and talents' user devices (i.e., PM devices and Talent devices, respectively) to perform various actions, via the talent sourcing server.

For example, the project managers may perform various actions, including creating/posting work requests, assigning chargeable work requests to the talent, obtaining deliverables created by the talent, providing feedback information, or the like, via the talent sourcing server. The talent may perform various actions, for example, including searching for available work requests, providing a request to be assigned to a chargeable work request, providing deliverables, receiving feedback information, or the like, via the talent sourcing server.

As shown in FIG. 1A, a first project manager (e.g., Project Manager 1) creates a first work request (e.g., Work Request A), including work request information associated with the first work request, using a first project manager device (e.g., PM Device 1). The first project manager device provides the first work request to the talent sourcing server. The first work request is a chargeable work request.

As shown in FIG. 1A, a second project manager (e.g., Project Manager 2) creates a second work request (e.g., Work Request B), including work request information associated with the second work request, using a second project manager device (e.g., PM Device 2). The second project manager device provides the second work request to the talent sourcing server. The second work request is a challenge work request.

As shown in FIG. 1A, the talent sourcing server obtains work requests, including work request information, profile information, gaming information, feedback information, and/or other information to facilitate assigning the chargeable work request to the talent. As shown in FIG. 1A, the talent sourcing server may facilitate assigning a talent (e.g., Talent 3) to the chargeable work request, based on receiving a request for assignment to the chargeable work request by the talent and based on receiving approval by the first project manager to assign the chargeable work request to the talent. As shown in FIG. 1A, the talent sourcing server may facilitate assigning other talent (e.g., Talent 1 and Talent 2) to the challenge work request, based on the other talent accepting/selecting to perform work, associated with the challenge work request, without approval from the second project manager.

As shown in FIG. 1B, assume the talent perform work associated with the work requests and/or provide deliverables. As shown in FIG. 1B, the talent sourcing server may generate a game score, determined by game points awarded to the talent (e.g., a game score of 200 game points awarded to Talent 1, a game score of 350 game points awarded to Talent 2, a game score of 400 game points awarded to Talent 3, etc.), based on performing/completing work associated with the work requests. The talent sourcing server and/or the project manager may determine the game points based on gaming information, including gaming guidelines (e.g., game points awarded for complexity of the work request, game points awarded for actual hours accrued for performing work associated with the work request, game points awarded based on a measure of quality of the deliverables, game points awarded based on a timing of deliverables relative to deadlines, other gaming rules, etc.).

The game score is a total of game points awarded for one or more work requests, associated with the talent. The talent sourcing server may use the game score (e.g., which may be displayed in a “score card” format, via the dashboard) and/or other information to determine feedback information (e.g., quantitative ratings for performance, comments, performance reviews, etc.) and/or incentives (e.g., rewards) for the talent.

By using crowdsourcing solutions for assigning/staffing projects, a company can optimally utilize the company's available and appropriate talent to complete projects and improve productivity (e.g., utilizing a knowledge-based company's talent, both a part of and external to a project team, possessing the desired skills and/or having available bandwidth to complete a particular work request). Additionally, using crowdsourcing solutions enables for project teams to be scaled up and/or scaled down to perform work associated with ad-hoc work requests. gamifying the crowdsourcing solutions may incentivize performance, provide innovation, reduce costs (e.g., by quickly and efficiently assigning/staffing the most appropriate talent), and achieve better, overall results, thereby providing value to customers of the company. Additionally, the PM device, the talent sourcing server, talent device, and/or another device may save processing power and resources by efficiently searching for and/or matching available and appropriate talent with available work requests.

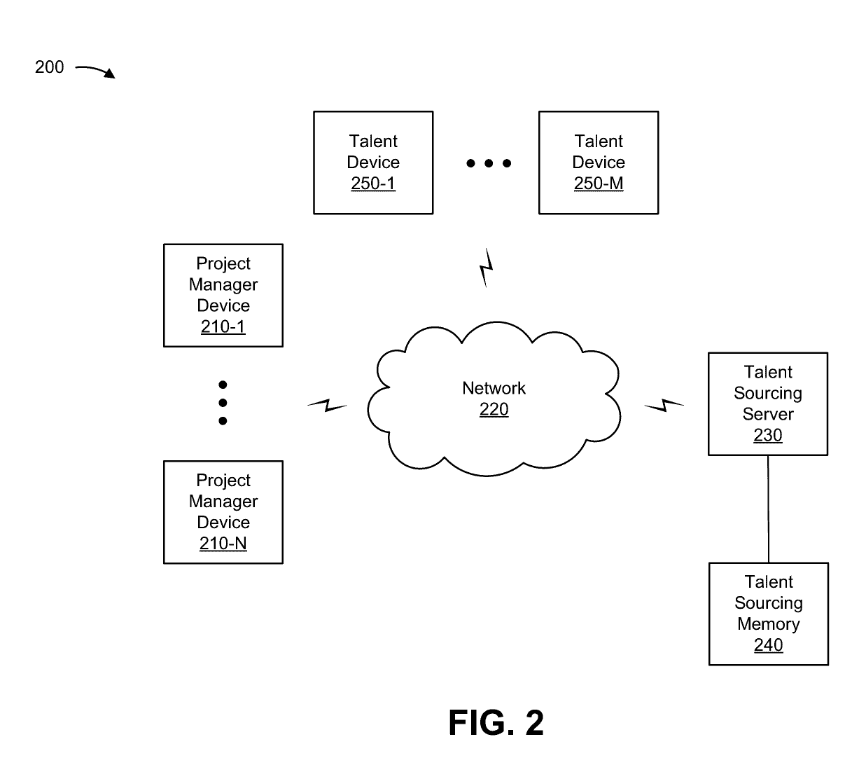

FIG. 2 is a diagram of an example environment 200 in which systems and/or methods, described herein, may be implemented. As shown in FIG. 2, environment 200 may include one or more project manager (PM) devices 210-1 through 210-N (N≧1)(hereinafter referred to collectively as “PM devices 210,” and individually as “PM device 210”), a network 220, a talent sourcing server 230, a talent sourcing memory 240, and one or more talent devices 250-1 through 250-M (M≧1)(hereinafter referred to collectively as “talent devices 250,” and individually as “talent device 250”). Devices of environment 200 may interconnect via wired connections, wireless connections, or a combination of wired and wireless connections.

PM device 210 may include a device capable of providing, presenting, and/or displaying information. For example, PM device 210 may include a mobile phone (e.g., a smart phone, a radiotelephone, etc.), a computing device (e.g., a desktop computer, a laptop computer, a tablet computer, a handheld computer, etc.), and/or a device of a similar type. In some implementations, PM device 210 may include a communication interface that allows PM device 210 to receive information from and/or transmit information to talent sourcing server 230 and/or another device. PM device 210 may, for example, create and/or post work requests, approve talent for the chargeable work requests, obtain deliverables associated with the work requests, provide feedback information, or the like.

Network 220 may include one or more wired and/or wireless networks. For example, network 220 may include a cellular network (e.g., a long-term evolution (LTE) network, a 3G network, a code division multiple access (CDMA) network, etc.), a public land mobile network (PLMN), a wireless local area network (e.g., a Wi-Fi network), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, and/or a combination of these or other types of networks.

Talent sourcing server 230 may include one or more server devices capable of generating, processing, and/or providing information. In some implementations, talent sourcing server 230 may generate, process, store, and/or provide, for example, work request information, profile information, feedback information, ranking/scoring information (e.g., a game score determined based upon game points awarded), or the like, to PM device 210, talent device 250, and/or another device. In some implementations, talent sourcing server 230 may receive information from and/or transmit information to PM device 210, talent sourcing memory 240, talent device 250, and/or another device.

Talent sourcing memory 240 may include one or more memory devices capable of processing, storing, and/or providing information. In some implementations, talent sourcing memory 240 may process, store, and/or provide information, such as work request information, profile information, feedback information, ranking/scoring information, or the like.

Talent device 250 may include a device capable of providing, presenting, and/or displaying information. For example, talent device 250 may include a mobile phone (e.g., a smart phone, a radiotelephone, etc.), a computing device (e.g., a desktop computer, a laptop computer, a tablet computer, a handheld computer, etc.), and/or a device of a similar type. In some implementations, talent device 250 may include a communication interface that allows talent device 250 to receive information from and/or transmit information to talent sourcing server 230 and/or another device. In some implementations, talent device 250 may accept assignment of a challenge work request. In some implementations, talent device 250 may submit a request for assignment for a chargeable work request. In some implementations, talent device 250 may perform various actions such as provide deliverables, receive and/or provide notifications, receive and/or provide feedback information, or the like.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

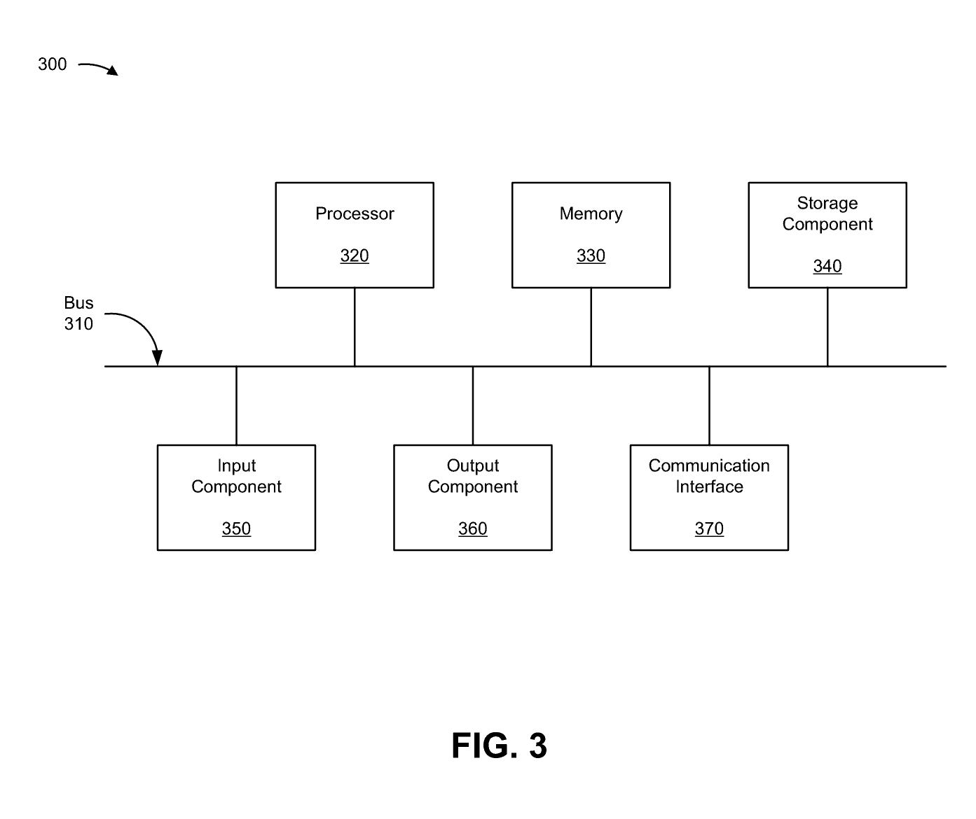

FIG. 3 is a diagram of example components of a device 300. Device 300 may correspond to PM device 210, talent sourcing server 230, talent sourcing memory 240, and/or talent device 250. In some implementations, PM device 210, talent sourcing server 230, talent sourcing memory 240, and/or talent device 250 may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 may include a component that permits communication among the components of device 300. Processor 320 is implemented in hardware, firmware, or a combination of hardware and software. Processor 320 may include a processor (e.g., a central processing unit (CPU), a graphics processing unit (GPU), an accelerated processing unit (APU), etc.), a microprocessor, and/or any processing component (e.g., a field-programmable gate array (FPGA), an application-specific integrated circuit (ASIC), etc.) that interprets and/or executes instructions. Memory 330 may include a random access memory (RAM), a read only memory (ROM), and/or another type of dynamic or static storage device (e.g., a flash memory, a magnetic memory, an optical memory, etc.) that stores information and/or instructions for use by processor 320.

Storage component 340 may store information and/or software related to the operation and use of device 300. For example, storage component 340 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 350 may include a component that permits device 300 to receive information, such as via user input (e.g., a touch screen display, a keyboard, a keypad, a mouse, a button, a switch, a microphone, etc.). Additionally, or alternatively, input component 350 may include a sensor for sensing information (e.g., a global positioning system (GPS) component, an accelerometer, a gyroscope, an actuator, etc.). Output component 360 may include a component that provides output information from device 300 (e.g., a display, a speaker, one or more light-emitting diodes (LEDs), etc.).

Communication interface 370 may include a transceiver-like component (e.g., a transceiver, a separate receiver and transmitter, etc.) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes in response to processor 320 executing software instructions stored by a computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

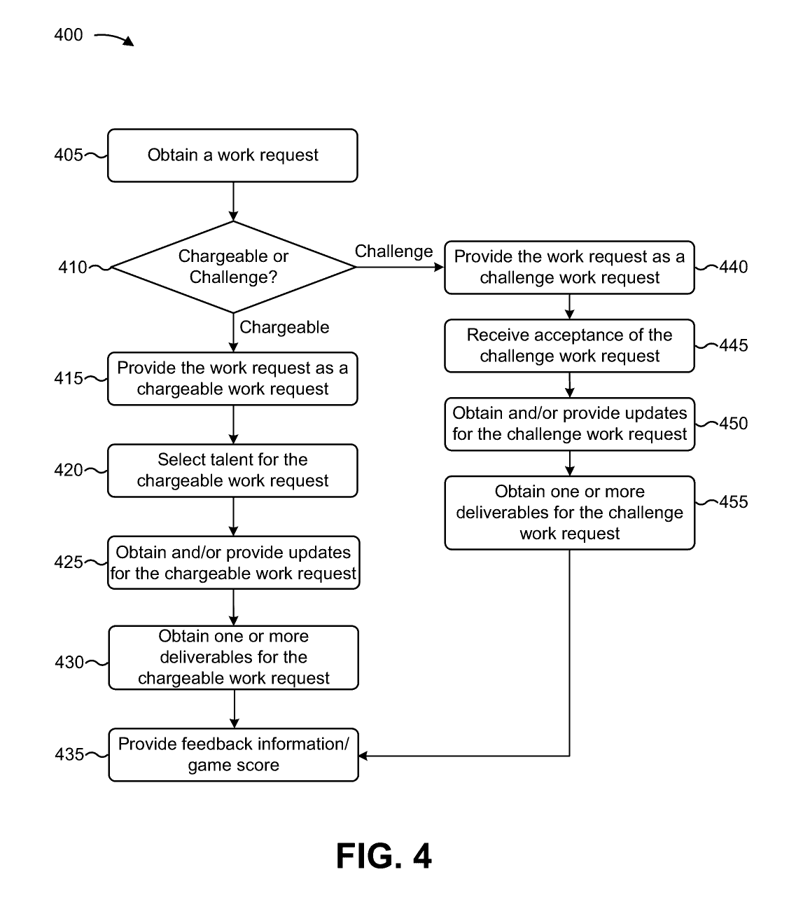

FIG. 4 is a flow chart of an example process 400 for using a system for sourcing talent utilizing crowdsourcing. In some implementations, one or more process blocks FIG. 4 may be performed by talent sourcing server 230. Additionally, or alternatively, one or more process blocks of FIG. 4 may be performed by another device or a set of devices separate from or including talent sourcing server 230, such as PM devices 210 and/or talent devices 250.

As shown in FIG. 4, process 400 may include obtaining a work request (block 405). For example, a user of PM device 210 (e.g., a project manager) may log into a talent sourcing application, provided by a company (e.g., a talent sourcing application provided by a knowledge-based company) and associated with talent sourcing server 230. The user of PM device 210 may create an account for the talent sourcing application by creating credentials (e.g., by creating a user name and/or password) and/or may log into the account by providing previously created credentials. In some implementations, the user of PM device 210 may interact with an input mechanism (e.g., by clicking a “Sign in” button to provide the previously created credentials to talent sourcing server 230 for authentication and/or authorization).

PM device 210 may provide a PM interface (e.g., a dashboard) for a user of PM device 210 to interact with the talent sourcing application. From the PM interface, PM device 210 may present various actions that the user of PM device 210 may perform, via talent sourcing server 230. The various actions may include accessing a list of previously created projects, associated with the user of PM device 210, provided by talent sourcing memory 240. The various actions may include creating a request to start a new project.

The various actions may include creating a work request by providing work request information. Work request information may include a work request title, a work request description, a work request category (e.g., documentation, source code, a presentation, etc.), a work request type (i.e., chargeable or a challenge), a project status (e.g., an open work request, a pending work request, etc.), an attribute type (e.g., analysis, design, other, etc.), a planned start date, a planned end date, an estimate of hours to perform work associated with the work request, an acknowledgement to a terms of agreement that the work request is eligible for crowdsourcing (e.g., acknowledgment by the user of PM device 210 that posting the work request for crowdsourcing abides by certain confidentiality terms in place with a client), a list of desired skills for talent, contact information, a billing code (e.g., a work back-down structured environment (WBSe)), location information (e.g., a geographic location where the work may be performed), attachments (e.g., documentation, source code, etc.), or the like.

The various actions may include updating and/or posting a work request, associated with one or more previously created projects provided on the list. The various actions may include searching for work requests based on criteria (e.g., a project identifier, a start date, an end date, estimated hours, etc.) to retrieve (e.g., by filtering) the work requests, meeting the criteria provided for the search. The various actions may include accessing a work request type. The various actions may include accessing and/or creating one or more deliverables/tasks and associated details for each of the work requests. The various actions may include sorting the work requests based on various formatting information (e.g., a work request title, a status, a start date, a work description, etc.), provided for display on the PM interface. The various actions may include accessing a support tool.

The various actions may include accessing frequent contributor information, including profile information for talent, performing work associated with the work requests, provided by talent sourcing memory 240. The frequent contributor information may also include a score card for the talent (e.g., a leaderboard). The score card may include a game score (e.g., a total for game points), for each of the talent, determined based on gaming information (e.g., based on a gamification calculation guide for determining the score card), for work performed, to assist the user of PM device 210 to identify suitable talent and/or select talent for assignment to a chargeable work request. The score card may include various categories for awarding game points (e.g., contributor game points, achiever game points, time keeper game points, etc.), used to determine the game score and a ranking of the talent for the various categories. The various actions may include accessing guidelines for selecting work eligible for crowdsourcing.

The various actions may also include accessing a list of open work requests. Open work requests are work requests that may be assigned to talent. A method of assigning the open work requests may depend on the work request type, associated with the open work requests. The various actions may also include accessing a list of work-in-progress requests. Work-in-progress requests are work requests previously assigned to talent. The various actions may also include accessing a list of completed work requests. Completed work requests are work requests for which requested deliverables have been provided and/or require no further action.

The various actions may include accessing a project status (e.g., a quantity of open work requests, a quantity of work-in-progress requests, a quantity of completed work requests, etc.), provided by talent sourcing memory 240. The various actions may include interacting with the talent, assigned to the work requests, using an on-line communication tool (e.g., by clicking on a link, associated with the talent assigned to the work request and/or other users of the system, to open a chat window with the user).

The various actions may include accessing notifications for action from the talent assigned to the work requests, associated with the user of PM device 210, provided by talent sourcing memory 240. The various actions may include accessing and/or providing feedback information (e.g., comments, a quantitative rating, etc.), provided by talent sourcing memory 240. For example, the user of PM device 210 may search for a talent using a talent identifier (e.g., a talent's name). The user of PM device 210 may access/provide feedback information for the talent, based on deliverables provided by the talent, associated with one or more work requests. The various actions may include obscuring (e.g., hiding) previously provided feedback information for the talent. The various actions may include exporting details of the work requests to an external program (e.g., a spreadsheet program, a database program, etc.).

These are just some examples of the various actions that may be performed, via talent sourcing server 230, through the PM interface of the talent sourcing application on PM device 210, and other various actions may be possible.

Additionally, or alternatively, the user of PM device 210 may create a work request by providing work request information to talent sourcing server 230, via the PM interface. Additionally, or alternatively, talent sourcing server 230 may obtain the work request, including the work request information, from PM device 210 as provided by the user of PM device 210.

In some implementations, talent sourcing server 230 may automatically generate work requests associated with projects, based on analyzing project requirements for the projects, provided by talent sourcing memory 240. For example, talent sourcing server 230 may analyze the project requirements to identify and/or create work requests to satisfy the project requirements. Additionally, or alternatively, talent sourcing server 230 may analyze the work requests, using the crowdsourcing guidelines provided by talent sourcing memory 240 (e.g., is not client sensitive, is not a critical milestone, able to be performed in parallel, code base for the work request not maintained by client, etc.), to identify work requests eligible for crowdsourcing.

In some implementations, talent sourcing server 230 may assign a crowdsourcing guideline (CG) score to each of the crowdsourcing guidelines, used for determining whether a work request is eligible for crowdsourcing. For example, each of the crowdsourcing guidelines may be assigned a level of importance (e.g., ‘is not client sensitive’ may be assigned as a most important factor, ‘is not be a critical milestone’ may be assigned a second most important factor, ‘able to be performed in parallel’ may be assigned as a third most important factor, etc.) by talent sourcing server 230 and/or another device.

Additionally, or alternatively, each of the crowdsourcing guidelines may be weighted based on an assigned level of importance, where the most important factor may receive a higher weighting than a less important factor (e.g., ‘may not be client sensitive’ may be determined as the most important factor and given a weight of 50%, ‘may not be a critical milestone’ may be determined of lesser importance and assigned a weight of 30%, ‘able to be performed in parallel’ may be determined as a factor of even lesser importance and may be assigned a weight of 20%, etc.).

Additionally, or alternatively, a total weight amount for all the crowdsourcing guidelines considered in determining the CG score may equal 100%. The work request may receive a point value (e.g., 1 point, 2 points, 3 points, etc.) for each of the crowdsourcing guidelines present, based on weights of the crowdsourcing guidelines.

The point value for the crowdsourcing guidelines (e.g., 10 points) is multiplied by the weight given to each of the crowdsourcing guidelines to calculate a CG score (e.g., ‘is not client sensitive’ may be given a CG score of 5 (10 points×0.50); ‘is not a critical milestone’ may be given a CG score of 3 (10 points×0.30); ‘able to be performed in parallel’ may be given a CG score of 2 (10 points×0.20); etc.).

In some implementations, talent sourcing server 230 may determine a total CG score by calculating a sum of one or more CG scores (e.g., a sum of one or more CG scores received for each of the crowdsourcing guidelines satisfied by the work request). For example, talent sourcing server 230 may determine the total CG score=10.

In some implementations, talent sourcing server 230 may identify a work request as eligible for crowdsourcing if the CG score satisfies a CG threshold score. For example, assume that the CG threshold score=5. Talent sourcing server 230 may identify a work request (e.g., WorkReq1) as eligible for crowdsourcing, where the total CG score for the work request=10 and satisfies the CG threshold score. Talent sourcing server 230 may identify another work request (e.g., WorkReq2) as not eligible for crowdsourcing, where the total CG score=3 for the other work request and does not satisfy the CG threshold score.

As further shown in FIG. 4, process 400 may include determining whether the work request is chargeable or a challenge (block 410). For example, talent sourcing server 230 may obtain the work request, included in the work request information, from PM device 210. Additionally, or alternatively, talent sourcing server 230 may parse the work request, including the work request information, to determine a work request type. The work request type may be a chargeable work request type (e.g., a first work request type) or a challenge work request type (e.g., a second work request type).

In some implementations, where talent sourcing server 230 automatically identifies and/or creates the work requests as eligible for crowdsourcing, talent sourcing server 230 may automatically determine a work request type, when creating the work request information, based on the project requirements (e.g., determines WorkReq1 as a chargeable work request, based on identifying a client associated with the project and based on the scope of WorkReq1 being within client billing guidelines, as provided by the client in the project requirements; determines WorkReq2 as a challenge based on identifying an internal (non-paying) client, associated with the project; etc.).

Additionally, or alternatively, talent sourcing server 230 may compare the work request type to stored work request types. If the work request type matches a stored work request type, indicating a chargeable work request, then talent sourcing server 230 may determine the work request is a chargeable work request. If the work request type matches a stored work request type, indicating a challenge work request, then talent sourcing server 230 may determine the work request is a challenge work request.

As further shown in FIG. 4, if the work request type matches a stored work request type indicating a chargeable work request (block 410—Chargeable), process 400 may include providing the work request as a chargeable work request (block 415). For example, talent sourcing server 230 may determine the work request to be a chargeable work request. Additionally, or alternatively, talent sourcing server 230 may provide the chargeable work request, including the associated work request information, to talent devices 250, marked as a chargeable work request.

A user (e.g., a talent) of talent device 250 may log into the talent sourcing application using talent device 250. The user of talent device 250 may create an account for the talent sourcing application by creating credentials (e.g., by creating a user name and/or password) and/or may log into the account by providing previously created credentials. In some implementations, the user of talent device 250 may interact with an input mechanism (e.g. a “Sign in” button) to provide the previously created credentials to talent sourcing server 230 for authentication/authorization.

Talent device 250 may provide a talent interface (e.g., a dashboard) for the talent sourcing application, for a user of talent device 250 to interact with the talent sourcing application. From the talent interface, talent device 250 may present various actions that the user of talent device 250 may perform, via talent sourcing server 230. For example, the various actions may include accessing and/or updating profile information, provided by talent sourcing memory 240. Profile information may include company profile information (e.g., the talent's name, the talent's company e-mail address, the talent's work telephone number, etc.).

Profile information may also include personal profile information (e.g., the talent's first name, the talent's middle name, the talent's last name, the talent's display name, the talent's company e-mail address, the talent's personal e-mail address, the talent's home telephone number, the talent's employee identifier, etc.). The company profile information and the personal profile information may be viewed from one talent interface or separate talent interfaces.

Profile information may also include skills details (e.g., a capability, a specialty, a skill, a start date, a proficiency rating, a career level, etc.). The various actions may include updating the profile information. In some implementations, talent sourcing server 230 may obtain updated profile information, provided by a user of talent device 250, to provide/highlight relevant information in response to a work request (e.g., the user of talent device 250 may update the profile information to align the user's skills with a chargeable work request to improve the user's chance of being selected for the chargeable work request).

The various actions may also include searching for available work requests based on a search criteria (e.g., a skill, a work request title, key terms, estimated hours, duration, etc.) to retrieve (e.g., by filtering) the work requests meeting the search criteria. The various actions may also include moving a scroll bar to change the criteria for the search based on estimated hours. In some implementations, the search criteria may be auto-populated based on the talent's skills details, as provided in the profile information.

The various actions may include clearing the search criteria (e.g., by clicking a ‘Reset’ button) to provide a new search criteria. The various actions may also include accessing results of the search for the available work requests. The various actions may also include sorting the results of the search for the available work request requests, based on various formatting information (e.g., a work request title, a status, a start date, work description, etc.), as displayed on the PM interface. The various actions may also include accessing a work request type (i.e., chargeable or a challenge). The various actions may include accessing a support tool.

The various actions may also include requesting assignment to a chargeable work request (e.g., by clicking a “Pick-up” button, associated with the chargeable work request, to trigger a request for assignment to the chargeable work request). The various actions may also include requesting assignment to a challenge work request (e.g., by clicking a “Pick-up” button, associated with the challenge work request, to trigger acceptance of the challenge work request).

The various actions may also include accessing a list of unapproved work requests. Unapproved work requests are chargeable work requests for which the talent has requested assignment but pending approval by a project manager, associated with creating and/or posting the chargeable work request.

The various actions may also include accessing a list of work-in-progress requests. Work-in-progress requests are work requests previously assigned to the talent, provided by talent sourcing memory 240. The various actions may also include accessing a list of completed work requests, provided by talent sourcing memory 240. Completed work requests are work requests for which requested deliverables have been provided by the talent and/or require no further action.

The various actions may also include may include accessing notifications (e.g., a notification that a project manager accepted the talent's request for assignment on a chargeable work request; requests for updates from a project manager; etc.), provided by talent sourcing memory 240.

The various actions may also include accessing activities/tasks information, provided by talent sourcing memory 240. For example, the activities/task information may include a completion rate (e.g., an on-time completion rate, a within estimates completion rate, etc.), a status (e.g., in progress, completed, pending review, pending allocation, etc.), or the like, for work requests assigned to the talent.

The various actions may also include accessing ranking/scoring information, provided by talent sourcing memory 240. The ranking/scoring information may include the score card providing the talent's game score and ranking. The score card may also include the game score and ranking for other users of talent device 250 (e.g., other talent). The various actions may also include accessing gaming information (e.g., a gamification calculation guide for determining the score card).

The various actions may include accessing feedback information (e.g., comments from a project manager, a quantitative rating provided by a project manager, etc.), provided by talent sourcing memory 240. The various actions may also include providing feedback information (e.g., providing feedback information, including ideas for improvement, to the project manager for future work requests; providing feedback information received from a project manager, based on completing the work request, to a supervisor/career counselor; etc.).

These are just some examples of the various actions that may be performed, via talent sourcing server 230, through the talent interface of the talent sourcing application on talent device 250, and other various actions may be possible.

Additionally, or alternatively, talent sourcing server 230 may provide a list of available work requests, including the chargeable work request obtained from PM device 210, based on a search performed for available work requests by the user of talent device 250. In some implementations, talent sourcing server 230 may automatically generate a list of available work requests based on various criteria (e.g. the user of talent device 250's skills profile, availability, other preferences, etc.) that may be of interest/desirable to the user of talent device 250). Talent sourcing server 230 may provide the automatically generated list of available work requests, based on the various criteria, to talent device 250.

The user of talent device 250 may access the list of available work requests and understand which work request may be chargeable and which work requests may be a challenge based on the work request type provided by talent sourcing server 230 (e.g., a field is populated as ‘Chargeable;’ a radio button next to a term=‘Chargeable’ is selected; the work request is sorted by the mark and located under a tab dedicated to chargeable work requests or challenge work requests; etc.).

As further shown in FIG. 4, process 400 may include selecting talent for the chargeable work request (block 420). For example, talent sourcing server 230 may receive a request for assignment, from one or more users of talent devices 250, to be selected for a chargeable work request (e.g., receive a request, submitted by the user of talent device 250, expressing interest in being staffed on the chargeable work request). The user of talent device 250 may interact with an input mechanism to provide the request for assignment (e.g., by clicking a ‘Pickup’ button, associated with the chargeable work request, to trigger the request for assignment).

Additionally, or alternatively, talent sourcing server 230 may provide a notification to talent device 250 that the request for assignment to the chargeable work request was received (e.g., by changing the ‘Pickup’ button to a ‘Pending Approval’ button, indicating the request for assignment was submitted to the project manager, associated with the chargeable work request, for approval before beginning work).

Additionally, or alternatively, talent sourcing server 230 may provide the request for assignment to PM device 210. Additionally, or alternatively, talent sourcing server 230 may provide a notification to PM device 210 that one or more users of talent device 250 has submitted a request for assignment (e.g., a quantity change for a field indicating one or more talent submitted requests to be assigned to a chargeable work request; a notification in the PM interface, providing one or more notifications for action for the user of PM device 210; etc.).

From the PM interface, PM device 210 may present various actions, related to accessing and/or accepting the submitted request for assignment, which the user of PM device 210 may perform, via talent sourcing server 230.

The various actions may include interacting with an input mechanism (e.g., a ‘Details’ button) to perform one or more steps for accepting the request. The one or more steps may include accessing a list of talent, submitting the request for assignment, including interactive contact information (e.g., a clickable e-mail address generating an e-mail that may be sent to the talent) and/or other profile information. The one or more steps may include accessing a comparing tool to compare one or more talent (e.g., by comparing performance reviews, by comparing feedback information, by comparing quantitative ratings, etc.), submitting the request for assignment (e.g., so that the project manager may select desired talent). The one or more steps may include assigning one or more users of talent devices 250 to the chargeable work request (e.g., selecting the talent by clicking an ‘Assign’ button, associated with the talent, to trigger assignment of the chargeable work request).

Additionally, the various actions may also include creating and/or adding deliverables to the chargeable work request. Additionally, or alternatively, talent sourcing server 230 may receive a notification that the one or more users of talent devices 250 were selected for the chargeable work request from PM device 210.

In some implementations, talent sourcing server 230 may provide a recommendation to PM device 210 which talent to select. For example, each user of talent device 250, submitting a request for assignment, may receive a skill score, rating a strength of the talent's skill (e.g., a strong, an average, or a weak score, a numerical score, a relevant or not relevant rating, etc.) against a list of desired skills for the chargeable work request. For example, each skill (e.g., a certain capability, a certain specialty, a certain proficiency rating, etc.) may be assigned a level of importance (e.g., possessing a certain capability may be assigned as a most important factor, possessing a certain specialty may be assigned a second most important factor, possessing a certain proficiency rating may be assigned as a third most important factor, etc.), based on the list of desired skills for the chargeable work request and/or some other factor.

Additionally, and/or alternatively, each skill may be weighted based on the assigned level of importance, where the most important skill may receive a higher weighting than a less important skill (e.g. possessing a certain capability may be determined as the most important skill and given a weight of 50%, possessing a certain specialty may be determined as a skill of lesser importance and assigned a weight of 30%, possessing a certain proficiency rating may be determined as a skill of even lesser importance and may be assigned a weight of 20%, etc.).

Additionally, and/or alternatively, a total weight amount for all the skills on the list of desired skills for the chargeable work request may equal 100%. The user of talent device 250, submitting the request for assignment, may receive a point value based on the level and/or quality of skill from the list of desired skills that the talent possesses (e.g., 0 points for no level and/or quality, 1 point for very little and/or a marginal level and/or quality, 2 points for some and/or a more higher level and/or quality, 3 points for a high level and/or quality, etc.). The point value for each skill (e.g., 3 points), from the list of desired skills that the user of talent device 250 possesses, is multiplied by the weight given to each skill to calculate a skill score (e.g., possessing a certain a certain capability may be given a skill score of 1.5 (3 points×0.50), possessing a certain specialty may be given a skill score of 0.90 (3 points×0.30), possessing a certain proficiency rating may be given a skill score of 0.60 (3 points×0.20), etc.). In some implementations, multiple skills may have the same measure of importance and may receive the same weighting.

In some implementations, a total skill score may be a sum of the individual skill scores received for each skill from the list of desired skills that the user of talent device 250 possesses (e.g., a talent possessing a certain capability, a certain specialty, and a certain proficiency rating may receive a total skill score of 3.00; a talent possessing a certain capability and a certain specialty may receive a total skill score of 2.40; a talent possessing only a certain capability may receive a total skill score of 1.50; etc.).

In some implementations, talent sourcing server 230 may recommend one or more users of talent devices 250, based on the one or more users of talent devices 250 receiving a skill score that satisfies a certain threshold, indicating a certain level of competency, for each of the skills on the list of desired skills for the chargeable work request. In some implementations, talent sourcing server 230 may recommend the one or more users of talent devices 250, receiving a total skill score that satisfies a certain threshold, indicating a certain level of overall competency. The threshold for the skill score and/or the total skill score may be input by an operator of talent sourcing server 230 and/or determined automatically, based on factoring a quantity of users of talent devices 250 available and a quantity of skills on the list of desired skills for the chargeable work request. This is one way of automating the threshold for the skill score and/or the total skill score, and other ways may be possible.

In some implementations, talent sourcing server 230 may receive requests for assignment for the same chargeable work request from talent devices 250, submitted by a multiple talent. Additionally, or alternatively, talent sourcing server 230 may recommend the user of talent device 250 receiving the highest skill score for each of the skills on the list of desired skills for the chargeable work request.

In some implementations, the available bandwidth to work on the chargeable work request may be a separate factor from the list of desired skills for the chargeable work request. The available bandwidth for a user of talent device 250, selected for recommendation (e.g., selected for recommendation because of receiving the highest total skill score), may be compared to an available bandwidth requirement (e.g., estimated hours) that may be included, for example, in the work request information for the chargeable work request. If the user of talent device 250 selected for recommendation has available bandwidth equal to or greater than the available bandwidth requirement included in the work request information, then the user of talent device 250 selected for recommendation is kept.

Otherwise, the user of talent device 250 selected for a recommendation is unselected and talent sourcing server 230 may select another user of talent device 250, having submitted a request for assignment to the same chargeable work request and having available bandwidth that is equal to or greater than the available bandwidth requirement included in the work request information (e.g., by selecting the talent receiving the second highest total skill score). In some implementations, the user of talent device 250 selected for a recommendation is unselected and talent sourcing server 230 may do nothing and/or wait for another request for assignment from a user of talent device 250.

In some implementations, if the user of talent device 250 selected for recommendation has available bandwidth less than the available bandwidth requirement, included in the work request information, and more than one user of talent device 250 has submitted a request for assignment to the same chargeable work request, then the user of talent device 250 is recommended (e.g., based on a decision to recommend talent with the highest total skill score) and talent sourcing server 230 may recommend another user of talent device 250 (e.g., receiving the second highest total skill score) to make up for any shortfall in the available bandwidth of the user of talent device 250, receiving the highest total skill score.

In some implementations, talent sourcing server 230 may provide requests for assignment, received from one or more users of talent devices 250, to PM device 210 without any recommendation. By talent sourcing server 230 providing a recommendation, PM device 210 may save processing power and resources by permitting talent sourcing server 230 to efficiently search for and/or match available and appropriate talent with available work requests. By talent sourcing server 230 not providing a recommendation, talent sourcing server 230 may save processing power and resources by permitting the project manager and/or PM device 210 to efficiently search for and/or match available and appropriate talent with available work requests, without having to rerun a search based on the project manager rejecting a recommendation provided by talent sourcing server 230.

Additionally, or alternatively, the user of PM device 210 may access profile information, feedback information, ranking/scoring information, a recommendation as determined by talent sourcing server 230, for the user of talent device 250 associated with the request for assignment, to determine whether to select the user of talent device 250 for the chargeable work request. If more than one user of talent devices 250 submit a request for assignment for the same chargeable work request, then the user of PM device 210 may access the comparing tool, via talent sourcing server 230, to compare the users of talent devices 250, submitting the request for assignment (e.g., by comparing performance reviews, by comparing feedback, by comparing, ratings, etc.).

Additionally, or alternatively, the user of PM device 210 may select the user of talent device 250 for the chargeable work request (e.g., selecting the talent by clicking an ‘Assign’ button, associated with the talent, to trigger assignment of the chargeable work request). In some implementations, if the user of PM device 210 does not desire to select the user of talent device 250 submitting the request for assignment, the user of PM device may do nothing and/or wait for another user of talent device 250 to submit a request for assignment.

In some implementations, talent sourcing server 230 may automatically select the user of talent device 250, based on the recommendation made by talent sourcing server 230. In some implementations, talent sourcing server 230 may reject for consideration a user of talent device 250 for not meeting all the skills on the list of desired skills for the chargeable work request. In some implementations, talent sourcing server 230 may provide a notification to PM device 210 so that the user of PM device 210 may understand which user of talent device 250 was selected for the chargeable work request. In some implementations, the user of PM device 210 may de-select the assigned user of talent device 250.

For example, talent sourcing server 230 may provide notification to PM device 210 that the user of talent device 250 was assigned (e.g., changing a status on the PM interface of the talent sourcing application, based on a user of PM device 210 selecting the talent; changing a status on the PM interface of the talent sourcing application, based on talent sourcing server 230 automatically selecting the talent; populating a field, associated with an actual start date, on the PM interface of the talent sourcing application based on a date the chargeable work request was assigned; etc.).

Additionally, or alternatively, talent sourcing server 230 may receive a billing code (e.g. a WBSe valid for a period of time) from PM device 210, provided by a user of PM device 210. In some implementations, the talent sourcing server 230 may provide a list of billing codes, received from talent sourcing memory 240, to PM device 210 for a user of PM device 210 to select, via the PM interface. In some implementations, talent sourcing server 230 may deny PM device 210 from changing a billing code for a certain period of time (e.g., denying a project manager from editing the billing code for a period of time prior to a validity period for the WBSe, via the PM interface; denying a project manager from editing the billing code for a period of time in the future after a validity period for the WBSe, via the PM interface; etc.). In some implementations, talent sourcing server 230 may permit PM device 210 to change the billing code for a certain period of time (e.g., permitting a project manager to edit the billing code during a period of time when the WBSe is valid).

As further shown in FIG. 4, process 400 may include obtaining and/or providing updates for the chargeable work request (block 425). For example, talent sourcing server 230 may provide a notification to talent device 250 that the user of talent device 250, submitting the request, was selected for/assigned to the chargeable work request and may begin performing work associated with the chargeable work request (e.g., the user of talent device 250 receives a notification, that the user was selected for the chargeable work request, by changing the ‘Pending Approval’ button in the talent interface to ‘Assigned;’ the user of talent device 250 receives a notification, that the user was selected for the chargeable work request, by moving the work request from a list of unapproved requests to a list of work-in-progress in the talent interface; etc.).

Additionally, or alternatively, talent sourcing server 230 may provide updated work request information provided by a user of PM device 210.

Additionally, or alternatively, talent sourcing server 230 may facilitate scheduling a meeting between the user of PM device 210, associated with the chargeable work request, and the user of talent device 250 assigned to the chargeable work request (e.g., the project manager may access the availability/calendar of the talent assigned to the work request to schedule a meeting).

Additionally, or alternatively, talent sourcing server 230 may provide a request for updates to talent device 250 from the user of PM device 210, and vice versa. Additionally, or alternatively, talent sourcing server 230 may facilitate communication between a user of PM device 210, using PM device 210, and a user of talent device 250, assigned to the chargeable work request and using talent device 250 (e.g., via a chat link available on the PM interface and/or the talent interface of the talent sourcing application).

Additionally, or alternatively, talent sourcing server 230 may provide profile information, associated with the user of talent device 250 assigned to the chargeable work request, to PM device 210 for future reference (e.g., the project manager may access the talent's profile information via a link available on the PM interface of the talent sourcing application).

In some implementations, talent sourcing server 230 may receive a quantity of hours for work performed, towards the chargeable work request, provided by a user of talent device 250 (e.g., the user of talent sourcing server 230 keeps track of the quantity of hours of work performed towards the chargeable work request, by associating the billing code to the quantity of hours, and provides the quantity of hours to talent sourcing server 230). Additionally, or alternatively, talent sourcing server 230 may provide the quantity of hours to PM device 210 for display, via the PM interface. In some implementations, talent sourcing server 230 may receive changes to the quantity of hours for work performed by PM device 210 (e.g., a project manager may overwrite the quantity of hours provided by the talent for billing). In some implementations, talent sourcing server 230 may deny the user of talent device 250 from editing the billing code.

As further shown in FIG. 4, process 400 may include obtaining one or more deliverables for the chargeable work request (block 430). For example, talent sourcing server 230 may receive one or more deliverables associated with the chargeable work request (e.g., a tangible work product for work performed associated with the chargeable work request) from talent device 250, provided by a user of talent device 250 via the talent interface (e.g., by uploading/attaching deliverables to the talent interface).

Additionally, or alternatively, talent sourcing server 230 may receive a notification that the chargeable work request is complete. In some implementations, a user of talent device 250 may change a submission status of the chargeable work request (e.g., a status change from ‘Work-in-Progress’ to ‘Submitted,’ associated with the chargeable work request, to trigger a notification to talent sourcing server 230).

Additionally, or alternatively, talent sourcing server 230 may validate the one or more deliverables. For example, talent sourcing server 230 may analyze, using analytic software, the one or more deliverables to determine whether the one or more deliverables satisfies the work request requirements (e.g., satisfies all the work request requirements associated with the chargeable work request, most of the work request requirements associated with the chargeable work request, etc.). If talent sourcing server 230 determines that the one or more deliverables satisfies the work request requirements, talent sourcing server 250 may mark the chargeable work request as complete (e.g., a status change from ‘Work-in-Progress’ to ‘Completed,’ for display via the PM interface).

In some implementations, talent sourcing server 230 may provide the one or more deliverables to PM device 210 to validate the one or more deliverables. Additionally, or alternatively, a user of PM device 210 may review the one or more deliverables and determine that the one or more deliverables satisfies the work request requirements. Additionally, or alternatively, talent sourcing server may obtain a notification from PM device 210 that the one or more deliverables satisfy the work request requirements (e.g., validating the one or more deliverables by changing a status of the chargeable work request from ‘Work-in-Progress’ to ‘Completed,’ via the PM interface).

Additionally, or alternatively, talent sourcing server 230 may generate a bill based on the one or more deliverables satisfying the chargeable work request. For example, talent sourcing server 230 may determine a bill amount based on the quantity of hours for work performed towards the chargeable work request, provided by the user of talent device 250 (e.g., multiplying the quantity of hours for work performed by a billing rate, associated with the billing code for the chargeable work request).

In some implementations, talent sourcing server 230 may provide the quantity of hours for work performed to another device (e.g., a billing device) to generate the bill. Additionally, or alternatively, talent sourcing server 230 may receive the bill generated from the other device. In some implementations, talent sourcing server 230 and/or another device may generate the bill, regardless of whether the one or more deliverables satisfies the work request requirements, associated with the work request.

Additionally, or alternatively, talent sourcing server 230 may provide the bill to PM device 210 for review/approval. In some implementations, talent sourcing server 230 may analyze the bill to determine whether the bill is valid (e.g., compliant with internal billing policies, compliant with client billing policies, associated with the billing code for the chargeable work request, etc.). If talent sourcing server 230 determines that the bill is valid, talent sourcing server 230 may submit the bill and/or provide the bill to another device for billing. If talent sourcing server 230 determines that the bill is not valid, talent sourcing server 230 may provide the bill to PM device 210 for consideration.

If talent sourcing server 230 determines that the one or more deliverables do not satisfy the work request requirements, talent sourcing server 230 may provide a notification to talent device 250 that the one or more deliverables do not satisfy the work request requirements for the chargeable work request. In some implementations, talent sourcing server 230 may provide information to talent device 250 so that a user of talent device 250 may understand why the one or more deliverables do not satisfy the work request requirements.

In some implementations, talent sourcing server 250 may obtain one or more additional/updated deliverables to satisfy the work request requirements. In some implementations, talent sourcing server 230 may iterate the process of determining whether the one or more additional/updated deliverables satisfy the work request requirements, providing a notification to talent device 250 that the one or more additional/updated deliverables do not satisfy the work request requirements, and/or obtaining one or more additional/updated deliverables until talent sourcing server 230 determines that the work request requirements are satisfied.

As described below, block 435 may also be applied to both chargeable work requests and challenge work requests.

As further shown in FIG. 4, process 400 may include providing feedback information and/or a game score (block 435). For example, a user of PM device 210 may receive notification that the user of talent device 250 provided a deliverable, associated with the work request, to PM device 210 via talent sourcing server 230 and the PM interface (e.g., the project manager receives a notification that a deliverable was received, via the PM interface). Additionally, or alternatively, a user of PM device 210 may access the deliverable.

Additionally, or alternatively, a user of PM device 210 may mark the work request as complete (e.g., a status change from ‘Work-in-Progress’ to ‘Completed,’ via the PM interface). Additionally, or alternatively, a user of PM device 210 may provide feedback to PM device 210 associated with the work request, via the PM interface. For example, the feedback may be a quantitative rating (e.g., a rating=2, a rating=3, a rating=4, etc.). Additionally, or alternatively, the feedback may be a qualitative comment (e.g., “nice job, “efficient and thorough,” “super,” etc.). Additionally, or alternatively, talent sourcing server 230 may receive the feedback from PM device 210. Additionally, or alternatively, talent sourcing server 230 may receive a notification that the work request is complete. In some implementations, talent sourcing server 230 may automatically change the status of the work request, displayed on the PM interface, to ‘complete’ based on receiving the feedback.

Additionally, or alternatively, talent sourcing server 230 may determine a game score to assign to the talent. For example, talent sourcing server 230 may determine game points (e.g., 10 game points, 20 game points, 30 game points, etc.) to award to the talent for completing the work, associated with the work request and based on guidelines included in the gaming information (e.g., game points awarded for contributing to a work request, game points awarded for achievement during performance of a work request, game points awarded for speed/efficiency in completing a work request, etc.). Additionally, or alternatively, talent sourcing server 230 may determine the game score for each user of talent device 250 by combining the game points awarded for all the work requests associated with each user of talent device 250.

For example, each user of talent device 250 submitting a request for assignment may receive a game score, rating a strength of the talent's performance/deliverable (e.g., a strong performance/deliverable, an average performance/deliverable, or a weak performance/deliverable, a numerical score, etc.) against the gaming guidelines. For example, each gaming guideline (e.g., game points awarded for contributing, game points awarded for achievement, game points awarded for speed/efficiency, etc.) may be assigned a level of importance (e.g., ‘game points awarded for contributing’ may be assigned as a most important factor, ‘game points awarded for achievement’ may be assigned a second most important factor, possessing a certain proficiency rating may be assigned as a third most important factor, etc.), based on the gaming guidelines and/or some other factor.

Additionally, and/or alternatively, each gaming guideline may be weighted based on the assigned level of importance, where the most important gaming guideline may receive a higher weighting than a less important gaming guideline (e.g. game points awarded for achievement may be determined as the most important gaming guideline and given a weight of 50%, game points awarded for speed/efficiency may be determined as a gaming guideline of lesser importance and assigned a weight of 30%, game points awarded for contributing may be determined as a gaming guideline of even lesser importance and may be assigned a weight of 20%, etc.).

Additionally, and/or alternatively, a total weight amount for all the gaming guidelines may equal 100%. The user of talent device 250, submitting a deliverable associated with the work request, may receive a game point value based on the level and/or quality of the deliverable (e.g., 0 game points for a poor deliverable, 100 game points for a good deliverable, 200 game points for a superior deliverable, etc.). The game point value for each gaming guideline (e.g., 100 game points) is multiplied by the weight given to each gaming guideline to determine the game points for each guideline (e.g., a good deliverable based on achievement may be given 50 game points (100 game points×0.50), a good deliverable based on speed/efficiency may be given 30 game points (100 game points×0.30), a good performance/deliverable based on contribution may be given 20 game points (100 game points×0.20), etc.). In some implementations, gaming guidelines may have the same measure of importance and may receive the same weighting.

In some implementations, the game points for each of the gaming guidelines may be combined to provide a game score for the user of talent device 250.

Additionally, or alternatively, talent sourcing server 230 may provide the game score to PM device 210 for display (e.g., as a score card/leaderboard). A user of talent device 250 may access the game score from the talent interface. Additionally, or alternatively, talent sourcing server 230 may provide rewards/incentives (e.g., a congratulatory e-mail, a monetary bonus, a work-related perk, etc.) to talent device 250 based on the game score (e.g., awarded to a top-scorer each month, awarded annually to a top-scorer, awarded to a top 10% of the scorers each month, etc.).

As further shown in FIG. 4, if the work request type matches a stored work request type indicating a challenge work request (block 410—Challenge), process 400 may include providing the work request as a challenge work request (block 440). For example, talent sourcing server 230 may provide the challenge work request to talent devices 250, marked as a challenge work request. Additionally, or alternatively, the user of talent device 250 may access the challenge work request, via the talent interface, as discussed above. Additionally, or alternatively, the user of talent device 250 may perform various actions through the talent interface, also discussed above.

As further shown in FIG. 4, process 400 may include receiving acceptance of the challenge work request (block 445). For example, the user of talent device 250 may determine whether the user desires to accept the challenge work request (e.g., by determining whether the user of talent device 250 possesses one or more skills from the list of desired skills, by determining whether the user of talent device 250 possesses bandwidth/availability to accept the challenge work request, by determining whether the user of talent device 250 possesses interest in the challenge work request, etc.). Additionally, or alternatively, the user of talent device 250 may accept the challenge work request by interacting with an input mechanism on talent device 250, via the talent interface (e.g., by clicking a ‘Pickup’ button, associated with the challenge work request to trigger the request for acceptance).

In some implementations, multiple talent devices 250 may accept the challenge work request. Additionally, or alternatively, talent sourcing server 230 may receive a notification that multiple users of talent devices 250 accepted the work request.

As further shown in FIG. 4, process 400 may include obtaining and/or providing updates for the challenge work request (block 450). For example, talent sourcing server 230 may receive a notification that the user of talent device 250 accepted the challenge work request. Talent sourcing server 230 may automatically assign the challenge work request to the user of talent device 250 (e.g., by changing the “Pick up” button to “Assigned,” without any input from PM device 210 and/or another device; the user of talent device 250 receives a notification, that the user was assigned the challenge work request, by moving the challenge work request from a list of unapproved requests to a list of work-in-progress in the talent interface; etc.).

In some implementations, talent sourcing server 230 may assign the challenge work request to each of the talent devices 250 that accept the challenge work request. For challenge work requests, talent sourcing server 230 does not make any independent determination of which talent device(s) 250 may accept the challenge work request. Talent sourcing server 230 may assign the challenge work request to any or all talent device(s) 250 accepting assignment of the challenge work request.

Additionally, or alternatively, talent sourcing server 230 may provide updated work request information provided by a user of PM device 210.

Additionally, or alternatively, talent sourcing server 230 may facilitate scheduling a meeting between the user of PM device 210, associated with the challenge work request, and the user of talent device 250 assigned to the challenge work request (e.g., the project manager may access the availability/calendar of the talent assigned to the challenge work request to schedule a meeting).

Additionally, or alternatively, talent sourcing server 230 may provide a request for updates to talent device 250 from the user of PM device 210, and vice versa. Additionally, or alternatively, talent sourcing server 230 may facilitate communication between a user of PM device 210, using PM device 210, and a user of talent device 250, assigned to the challenge work request and using talent device 250 (e.g., via a chat link available on the PM interface and/or the talent interface of the talent sourcing application).

Additionally, or alternatively, talent sourcing server 230 may provide profile information, associated with the user of talent device 250 assigned to the challenge work request, to PM device 210 for future reference (e.g., the project manager may access the talent's profile information via a link available on the PM interface of the talent sourcing application).

As further shown in FIG. 4, process 400 may include obtaining one or more deliverables for the challenge work request (block 455). For example, talent sourcing server 230 may receive one or more deliverables associated with the challenge work request (e.g., a tangible work product for work performed associated with the challenge work request) from talent device 250, provided by a user of talent device 250 via the talent interface (e.g., by uploading/attaching deliverables to the talent interface).

Additionally, or alternatively, talent sourcing server 230 may receive a notification that the challenge work request is complete. In some implementations, a user of talent device 250 may change a submission status of the challenge work request (e.g., a status change from ‘Work-in-Progress’ to ‘Submitted,’ associated with the challenge work request, to trigger a notification to talent sourcing server 230).

Additionally, or alternatively, talent sourcing server 230 may validate the one or more deliverables. For example, talent sourcing server 230 may analyze, using analytic software, the one or more deliverables to determine whether the one or more deliverables satisfies the work request requirements (e.g., satisfies all the work request requirements associated with the challenge work request, most of the work request requirements associated with the challenge work request, etc.). If talent sourcing server 230 determines that the one or more deliverables satisfies the work request requirements, talent sourcing server 250 may mark the challenge work request as complete (e.g., a status change from ‘Work-in-Progress’ to ‘Completed,’ for display via the PM interface).

In some implementations, talent sourcing server 230 may provide the one or more deliverables to PM device 210 to validate the one or more deliverables. Additionally, or alternatively, a user of PM device 210 may review the one or more deliverables and determine that the one or more deliverables satisfy the work request requirements. Additionally, or alternatively, talent sourcing server 230 may obtain notification from PM device 210 that the one or more deliverables satisfy the work request requirements (e.g., validating the one or more deliverables by changing a status of the challenge work request from ‘Work-in-Progress’ to ‘Completed,’ via the PM interface).

If talent sourcing server 230 determines that the one or more deliverables do not satisfy the work request requirements, talent sourcing server 230 may provide a notification to talent device 250 that the one or more deliverables do not satisfy the work request requirements for the challenge work request. In some implementations, talent sourcing server 230 may provide information to talent device 250 so that a user of talent device 250 may understand why the one or more deliverables does not satisfy the work request requirements.

In some implementations, talent sourcing server 230 may obtain one or more additional/updated deliverables to satisfy the work request requirements. In some implementations, talent sourcing server 230 may iterate the process of determining whether the one or more additional/updated deliverables satisfies the work request requirements, providing a notification to talent device 250 that the one or more additional/updated deliverables do not satisfy the work request requirements, and obtaining one or more additional/updated deliverables until talent sourcing server 230 determines that the work request requirements is satisfied.

In some implementations, talent sourcing server 230 may select one or more validated deliverables of the one or more deliverables as the best (e.g., satisfying all work request requirements with high quality deliverables, satisfying most of the work request requirements with high quality deliverables, etc.). The one or more validated deliverables, selected as the best, may have been provided by one or more talent devices 250. In some implementations, talent sourcing server 230 may select one or more deliverables as the best, without validating the one or more deliverables.

When the one or more deliverables, associated with the challenge work requests, are validated and/or selected as the best, process 400 may continue with block 435 for the challenge work request, as described above. In some implementations, when talent sourcing server 230 selects one or more deliverables as the best, talent sourcing server 230 may receive positive feedback for the one or more deliverables, thereby increasing the game score for the user of talent device 250, associated with providing the one or more deliverables selected as the best. In some implementations, only the user(s) of the talent device(s) 250, associated with the one or more deliverables selected as the best, may obtain rewards/incentives from talent sourcing server 230.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

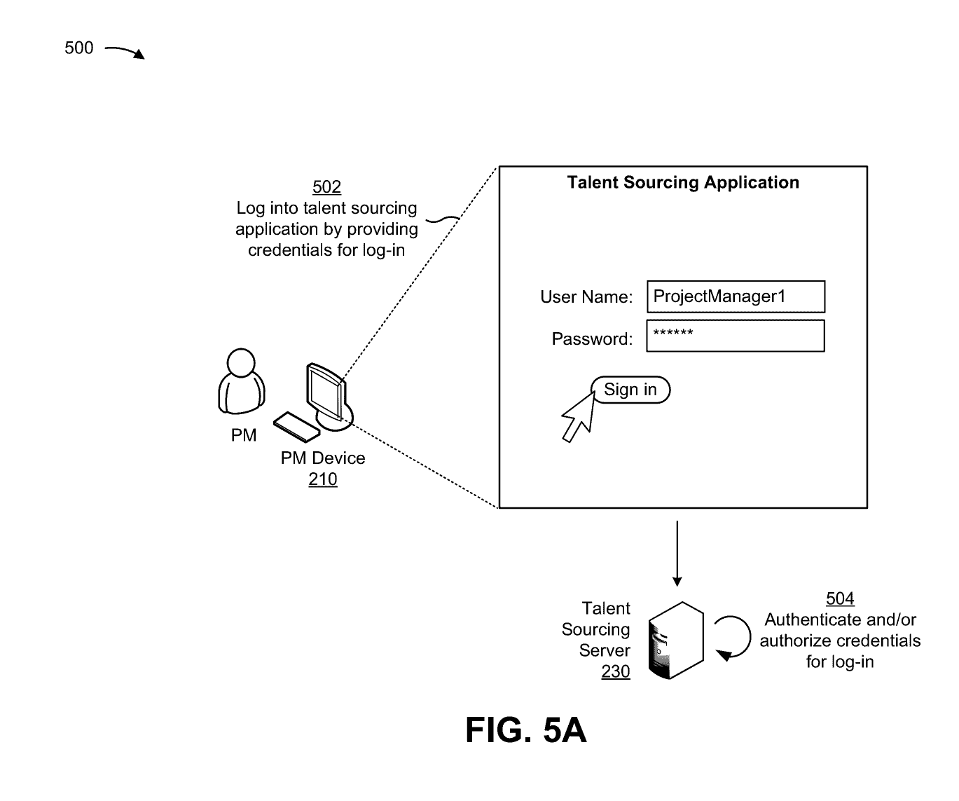

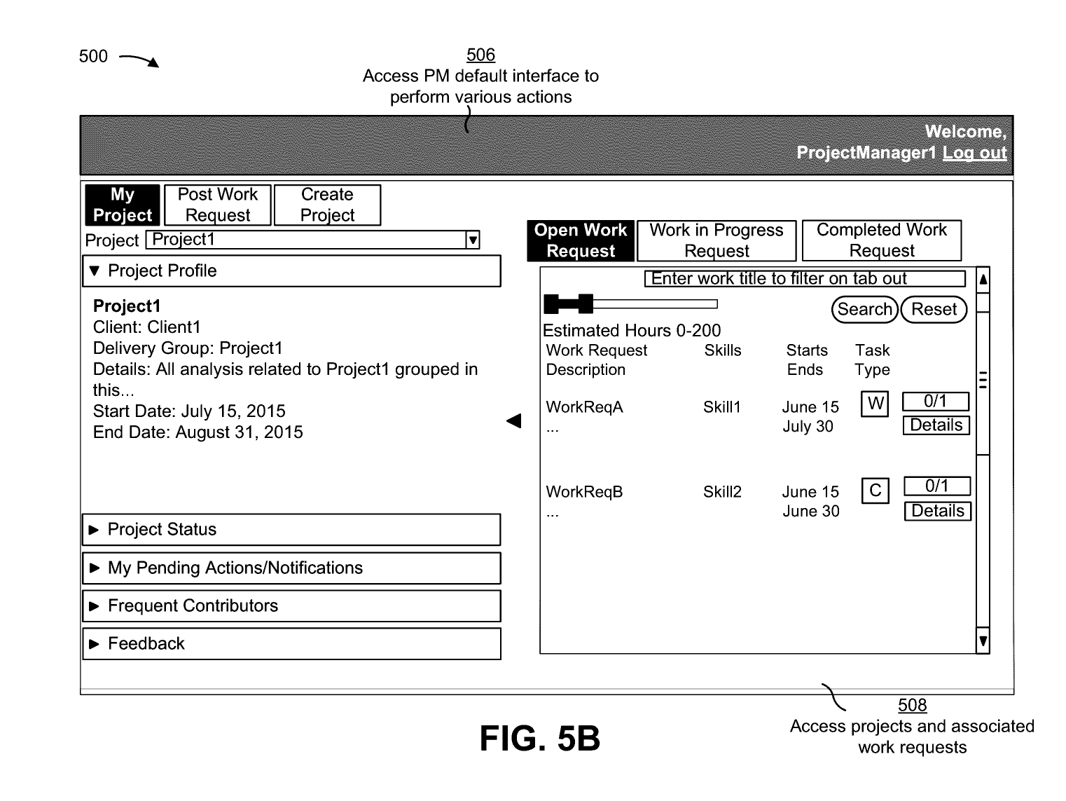

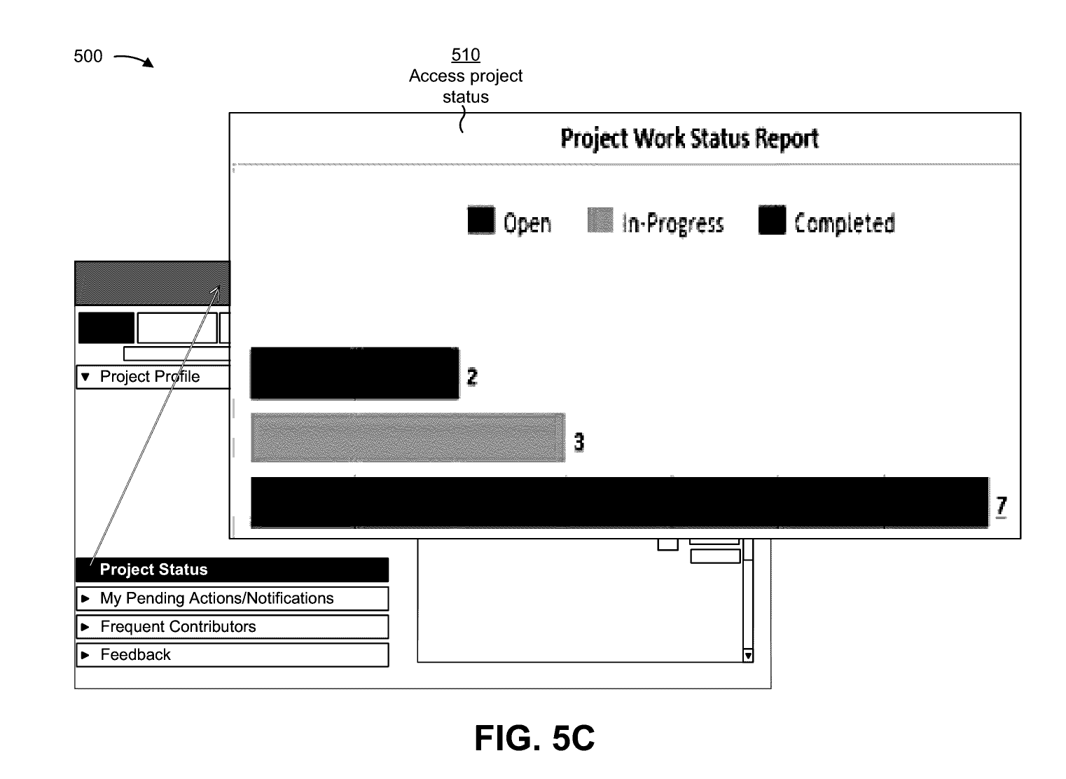

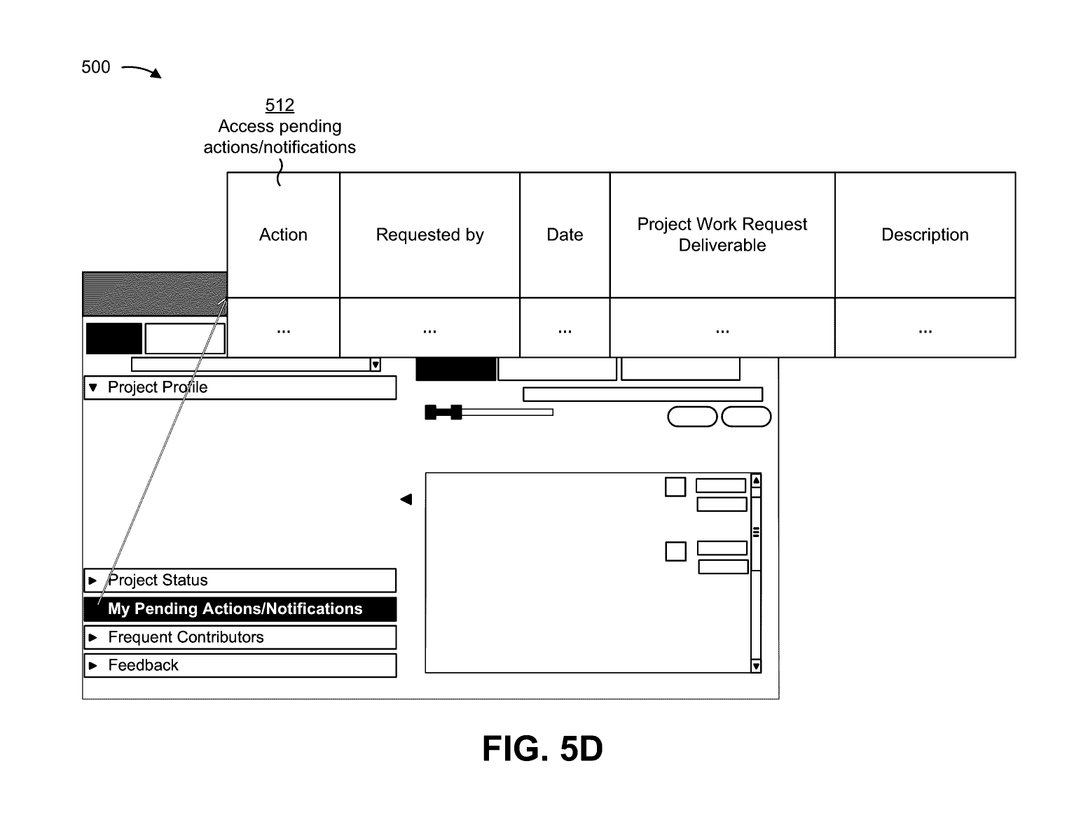

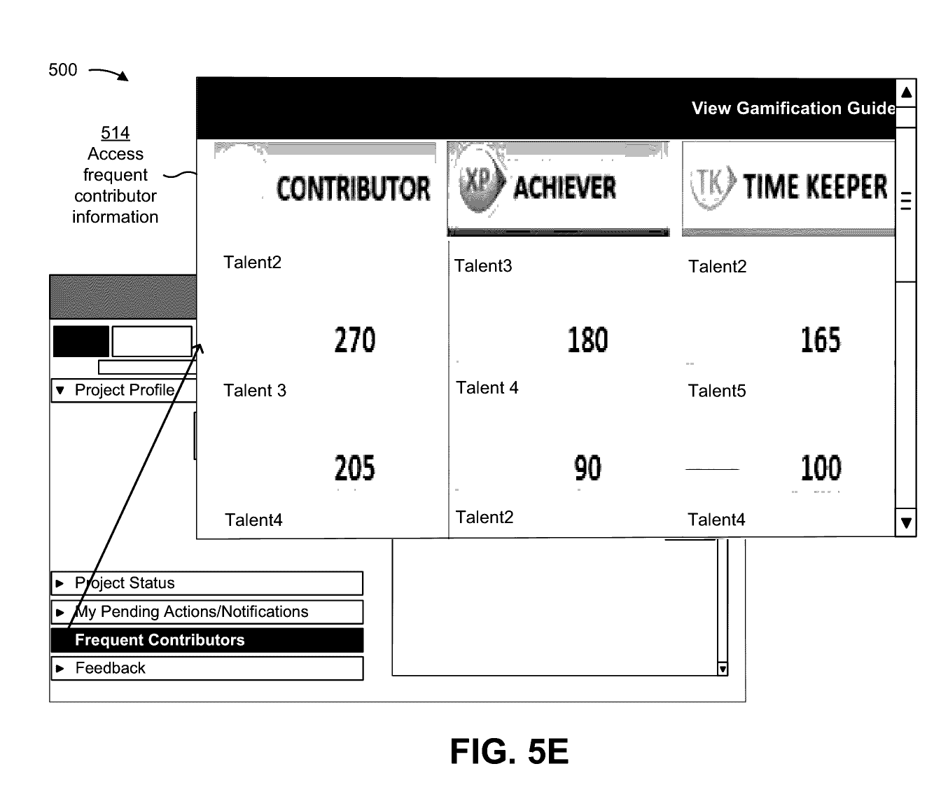

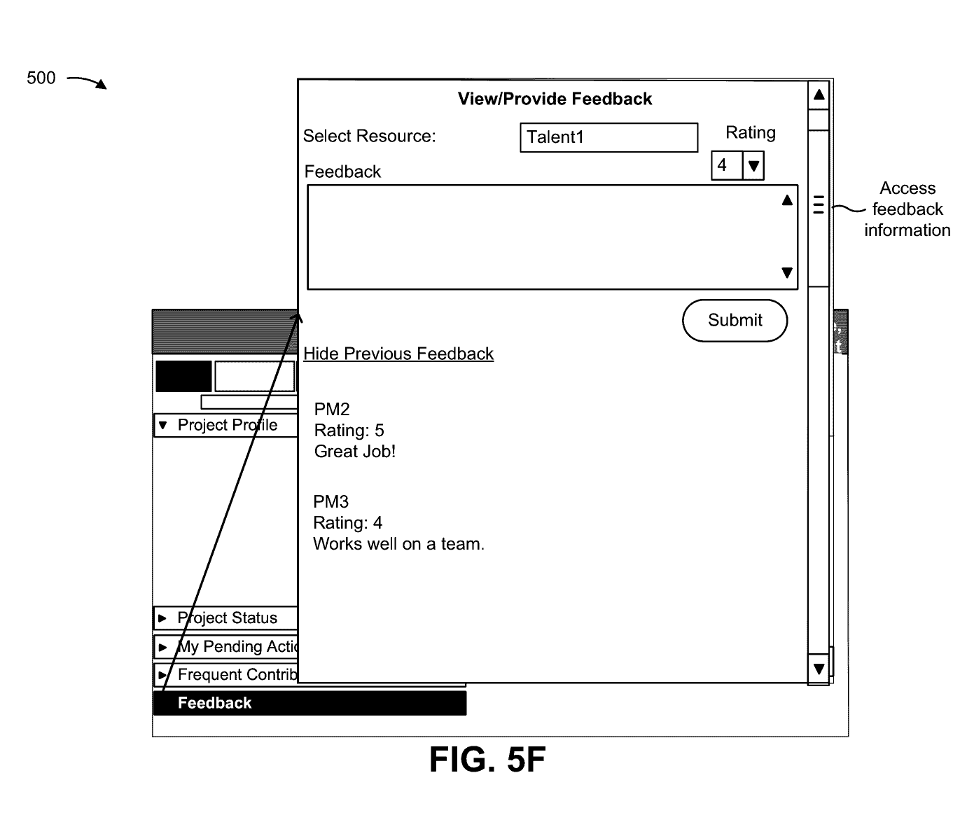

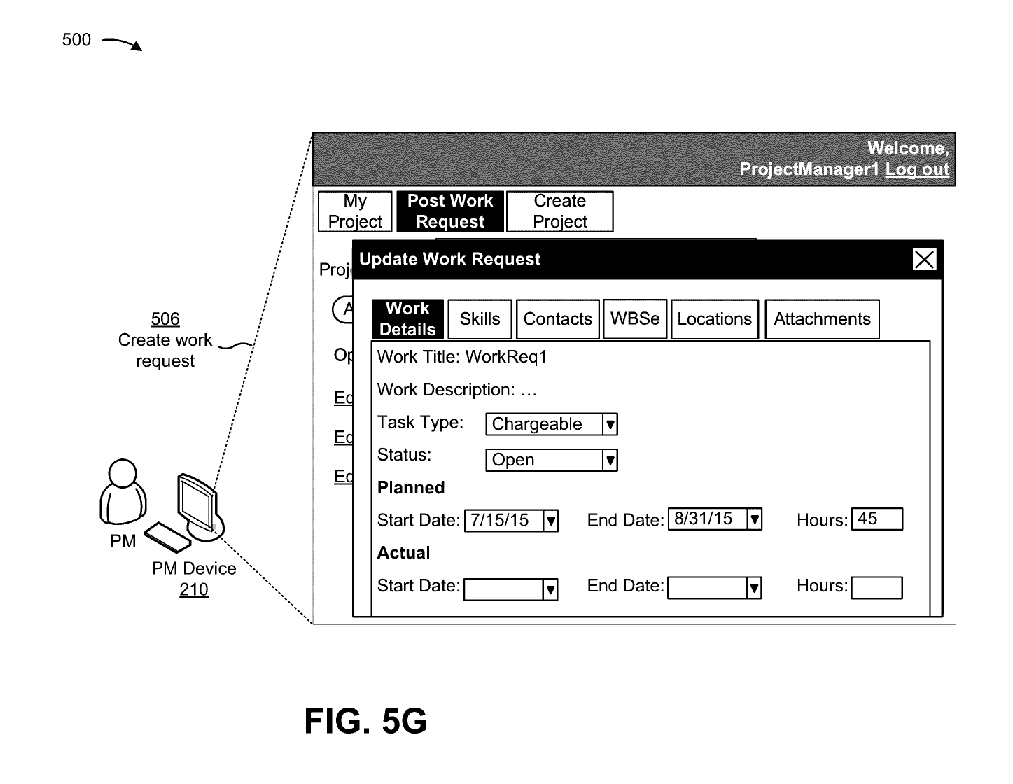

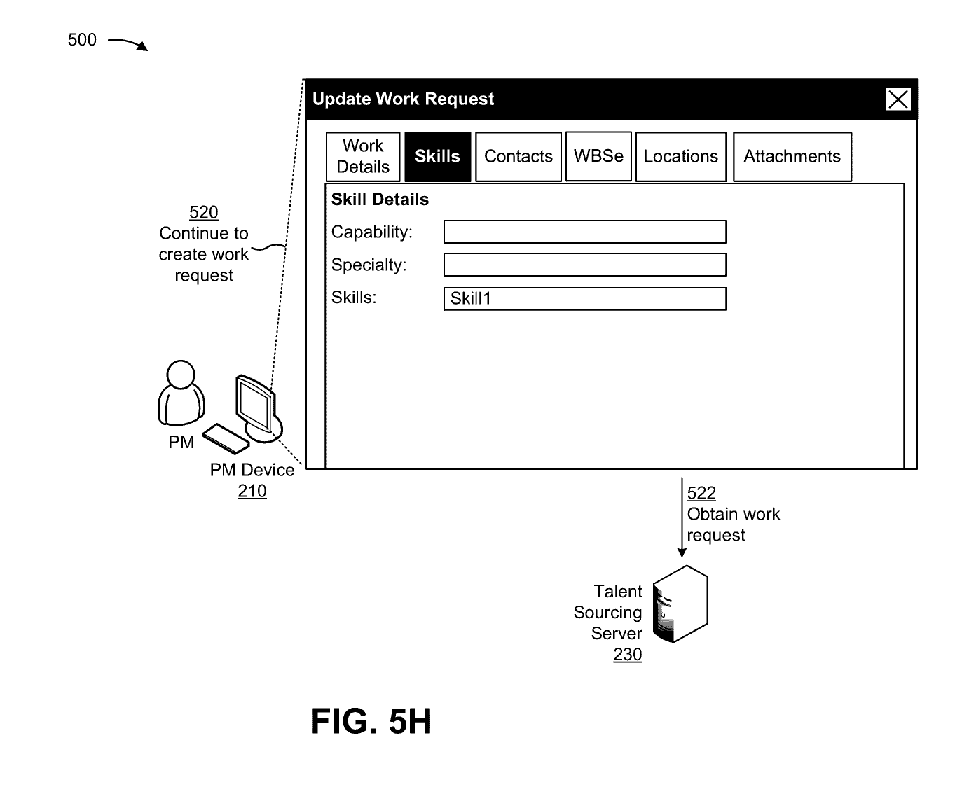

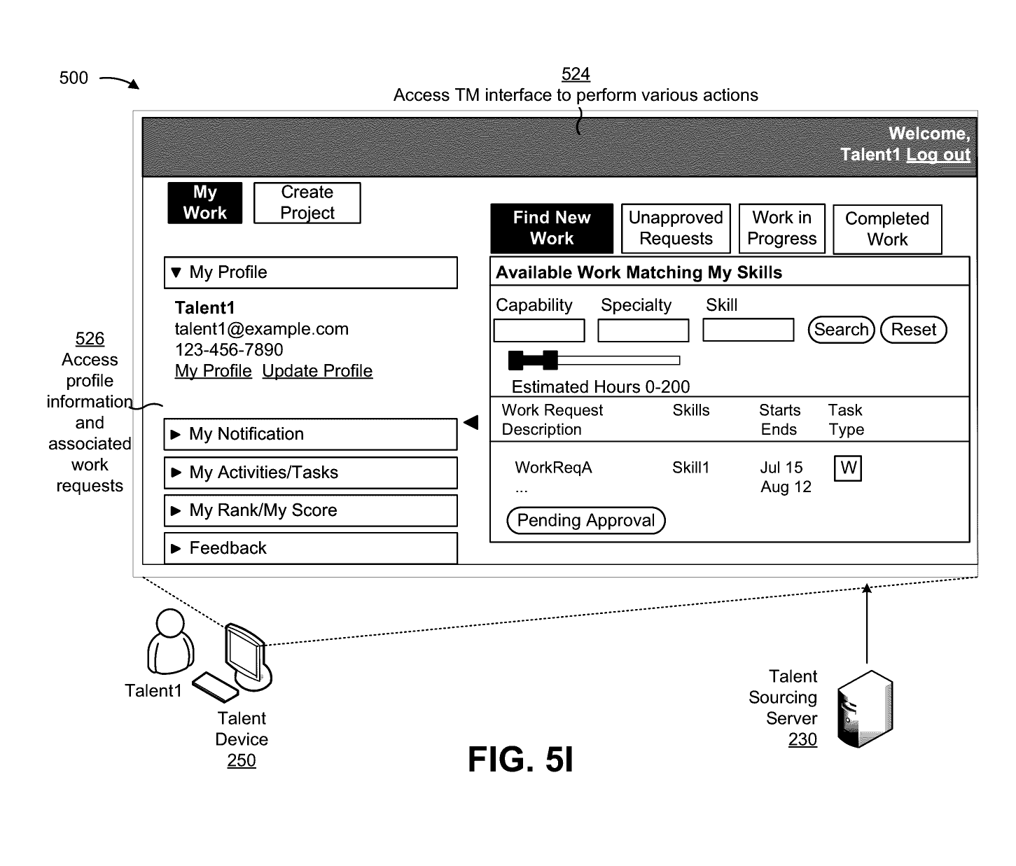

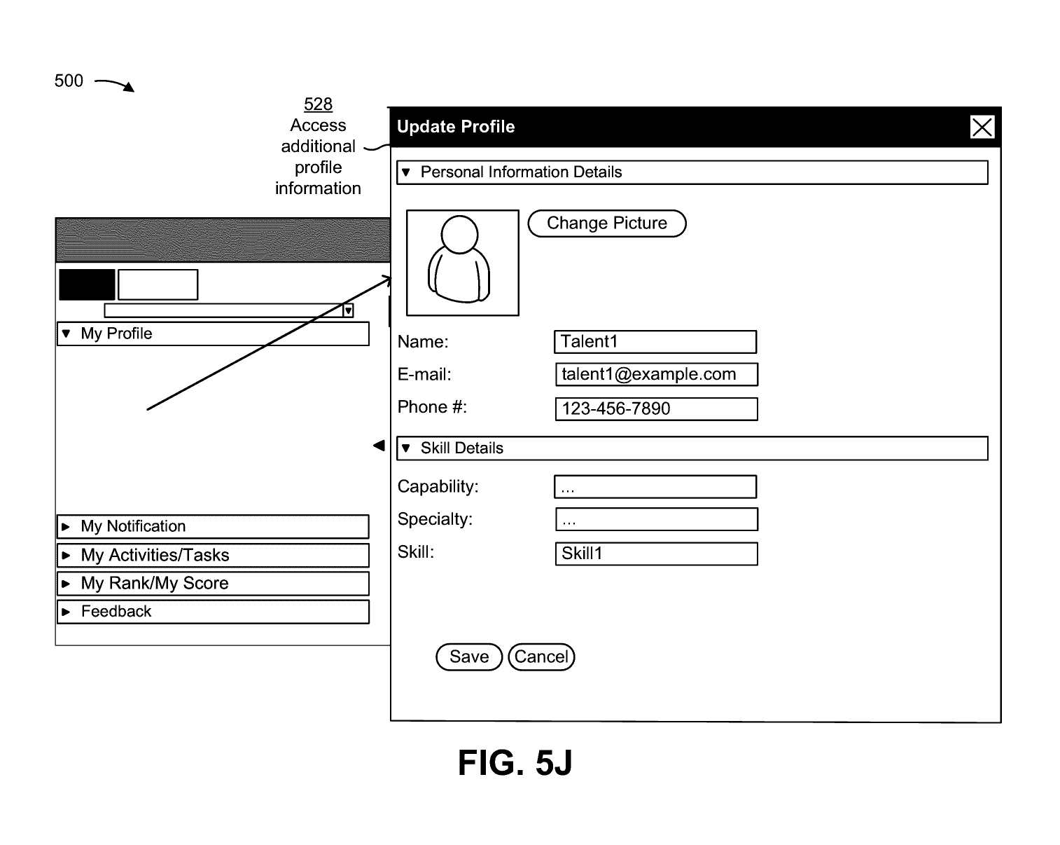

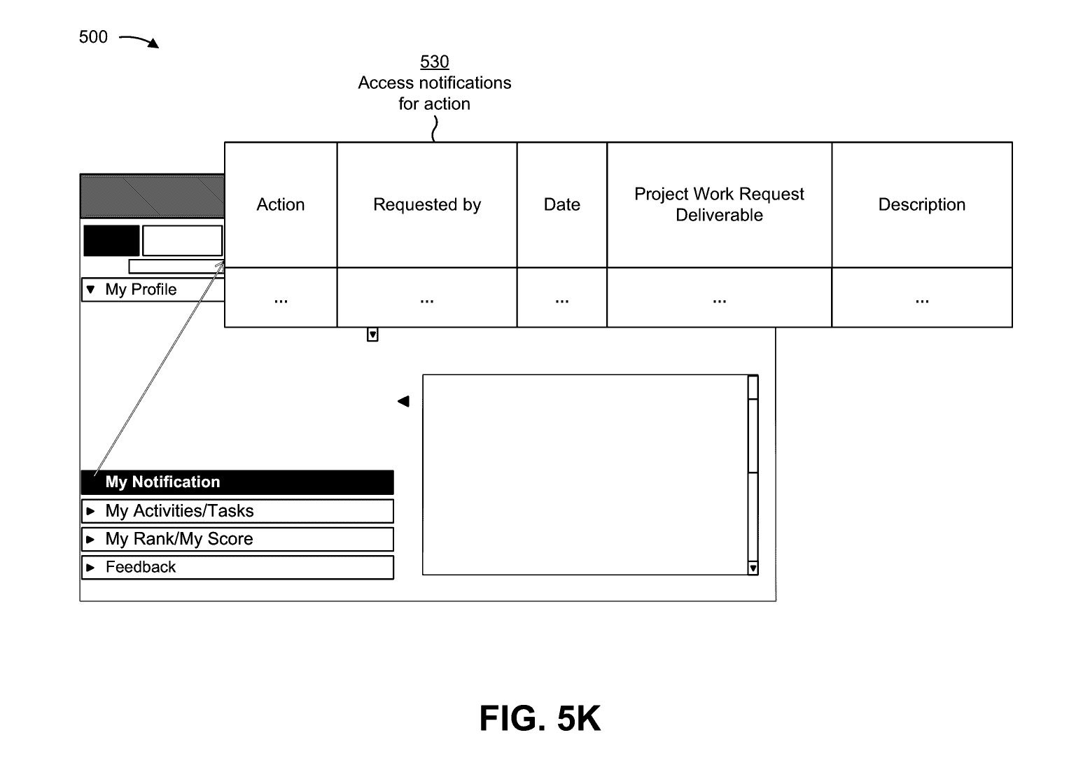

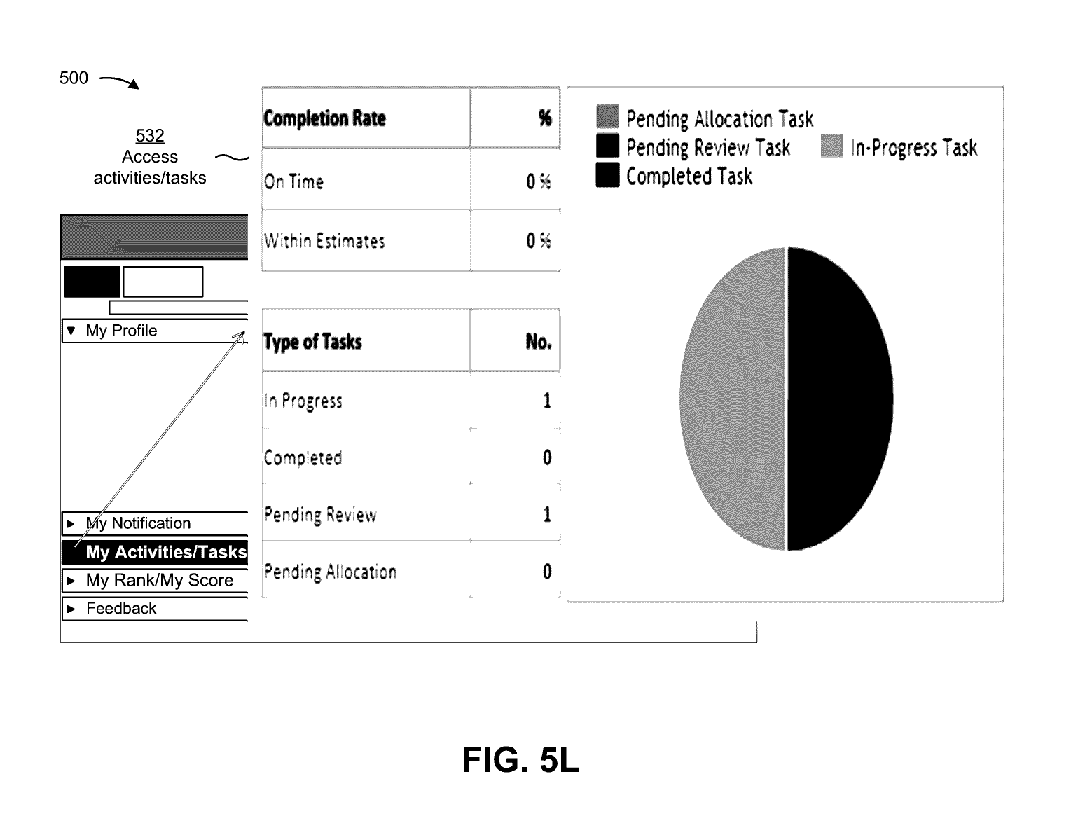

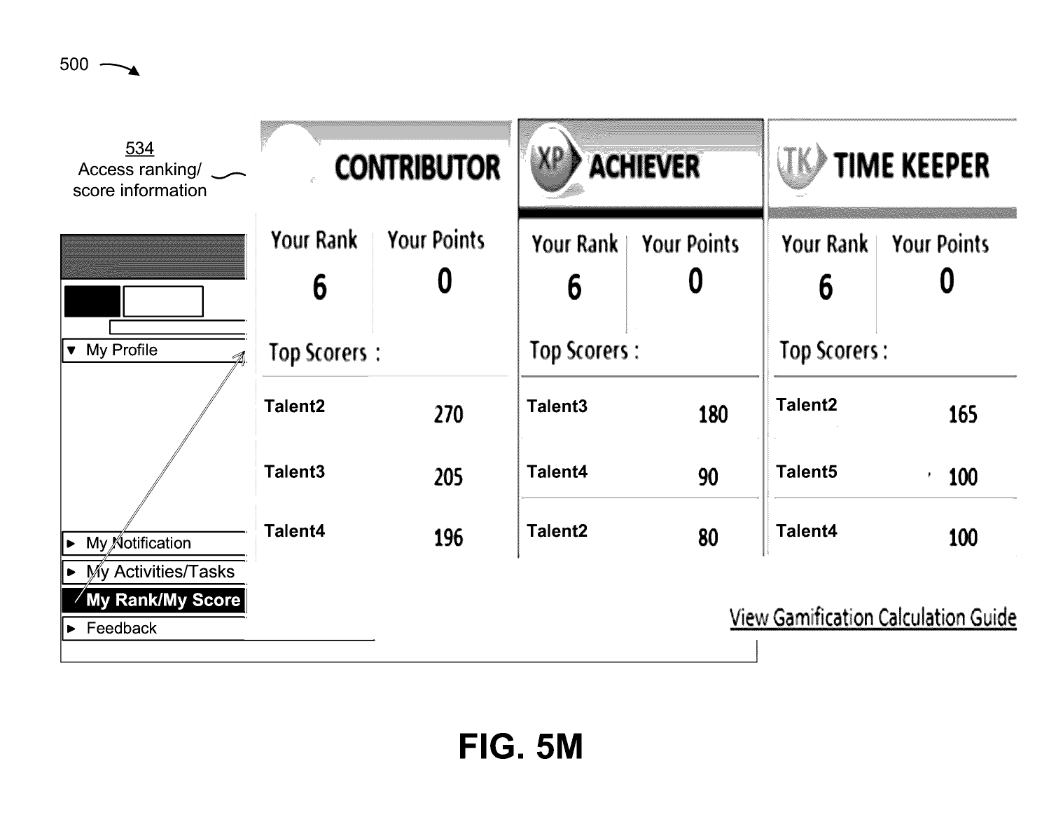

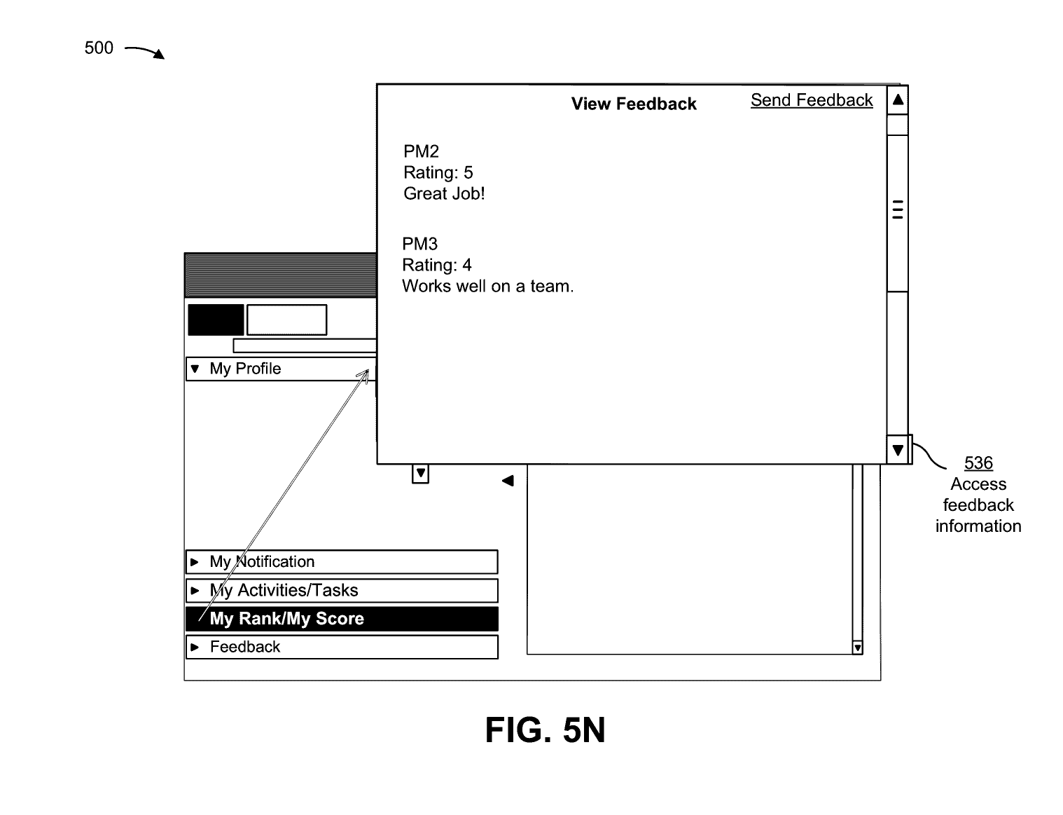

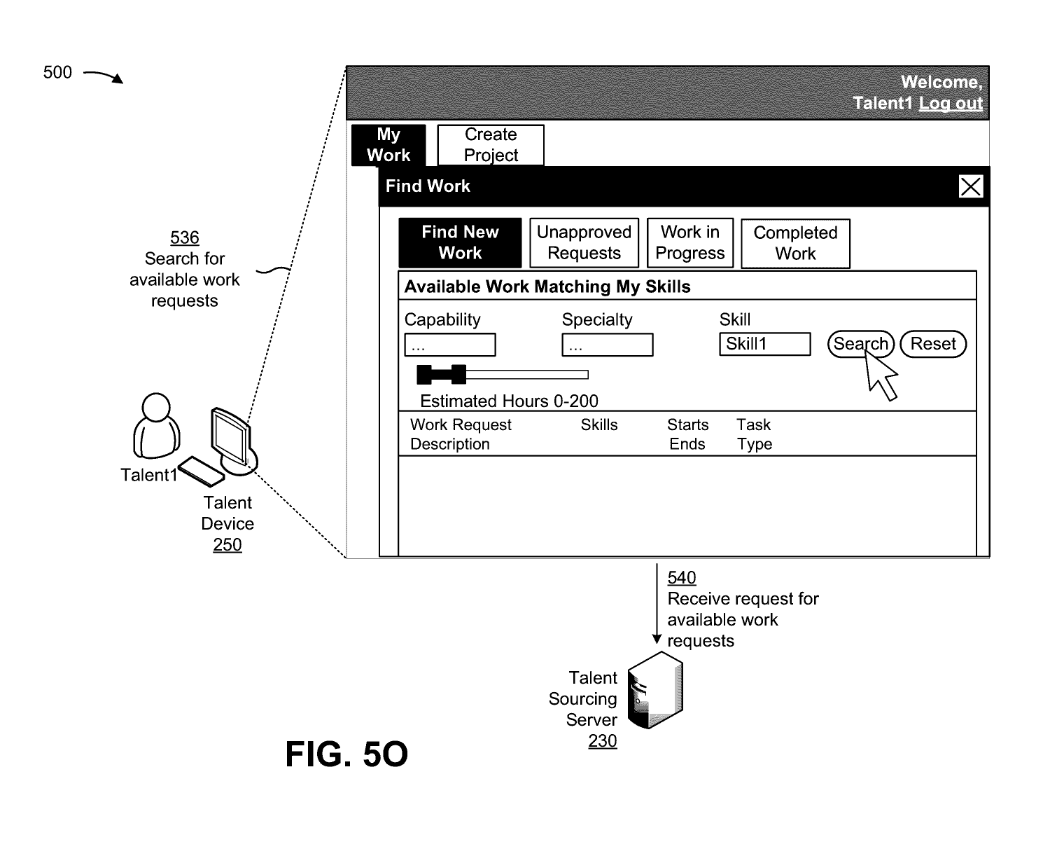

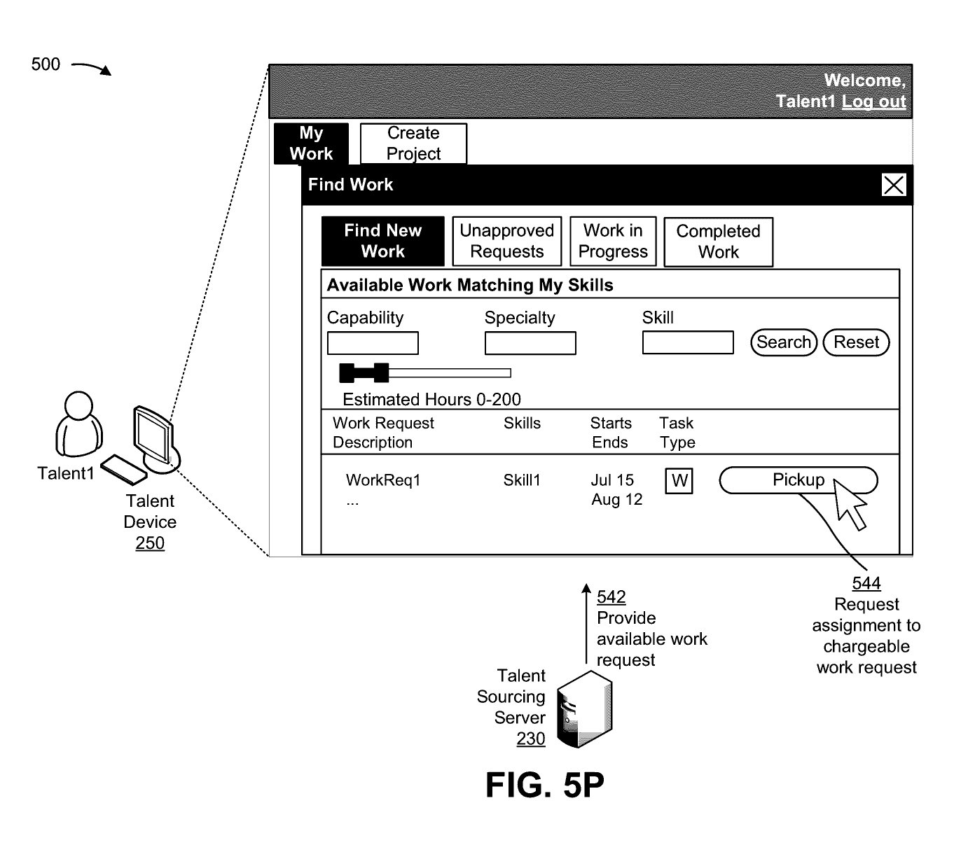

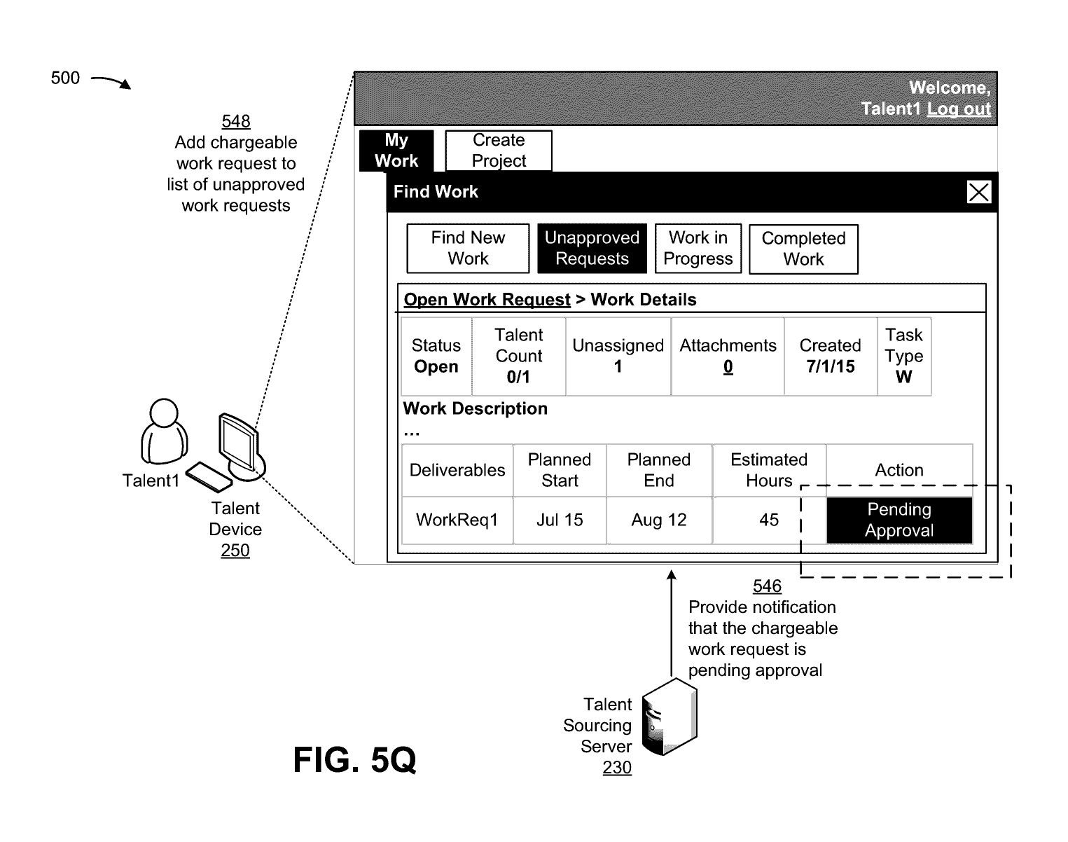

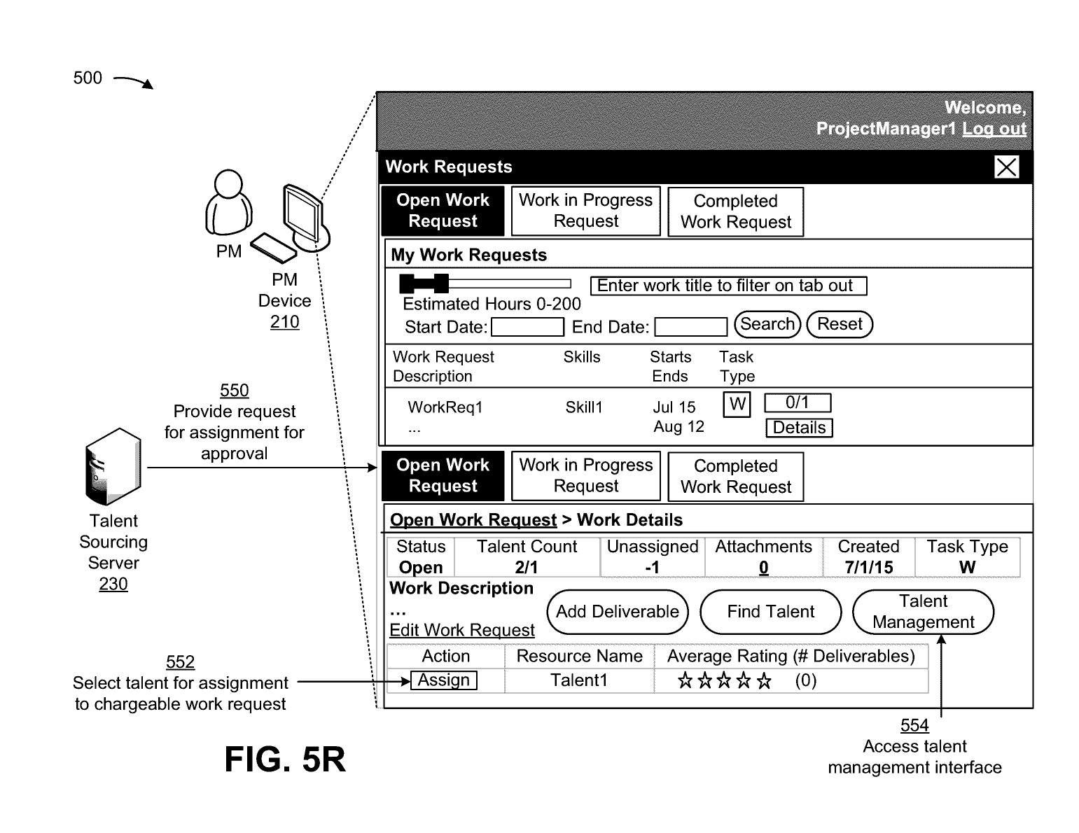

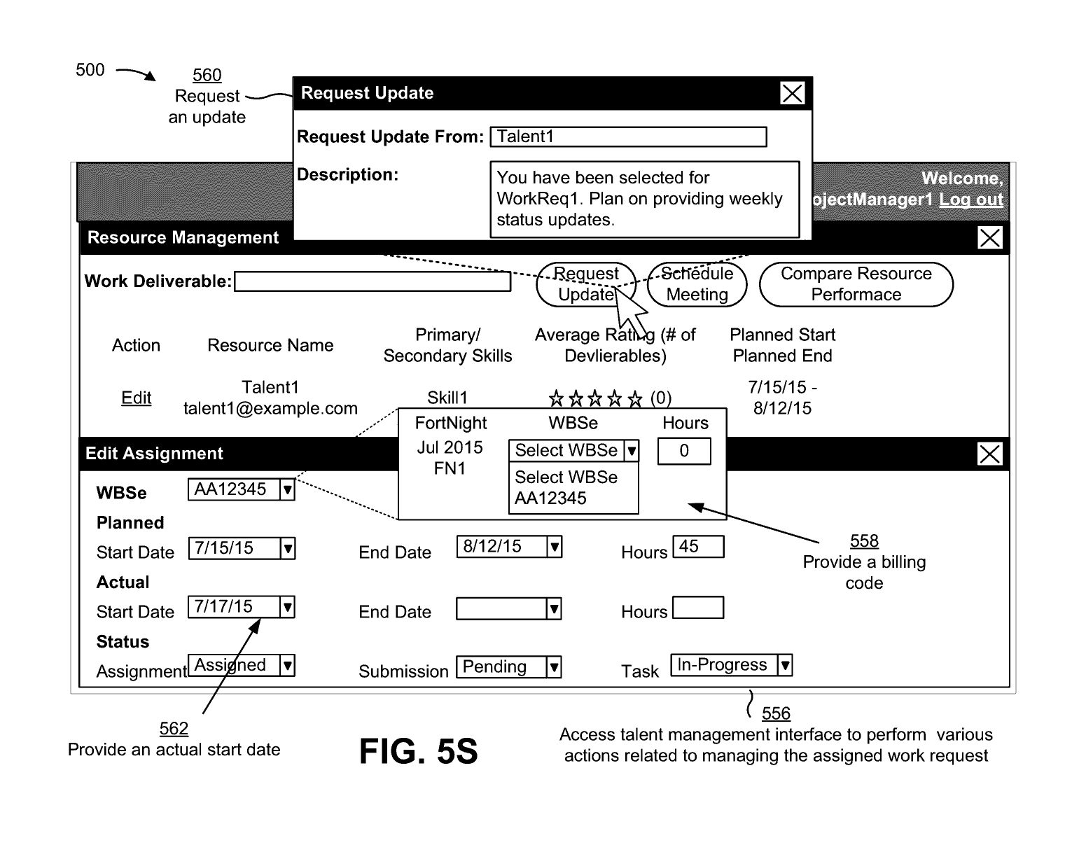

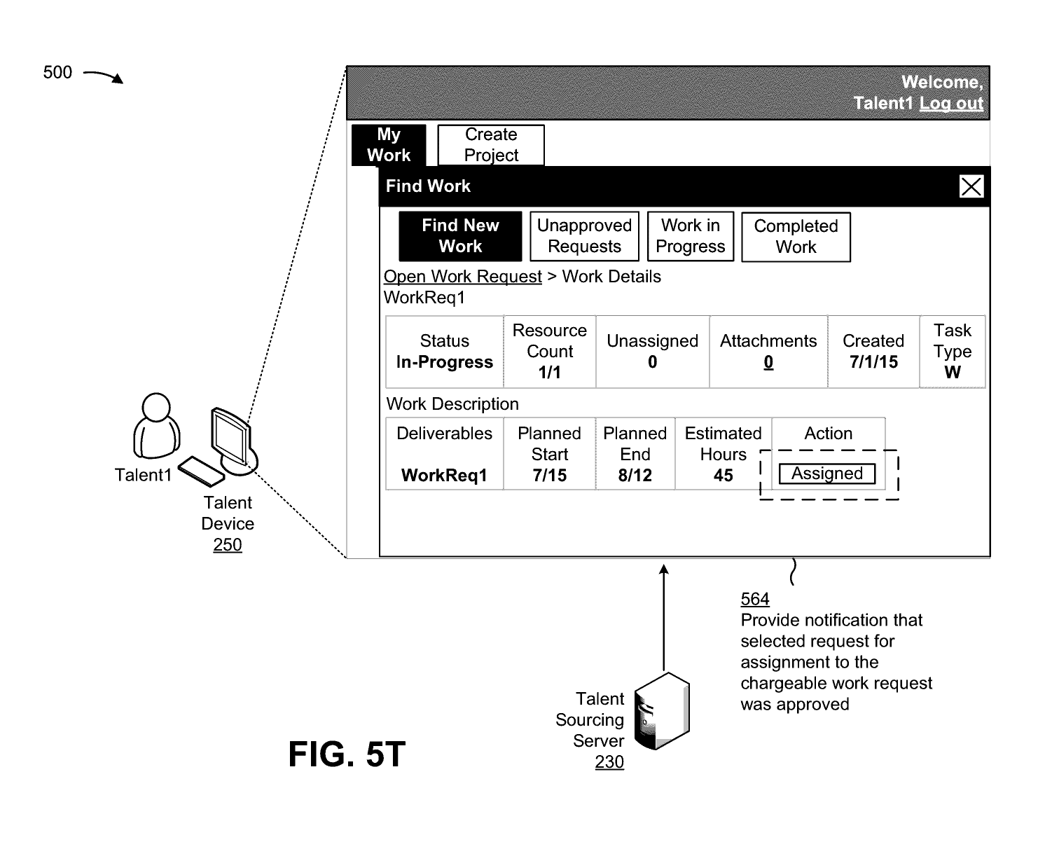

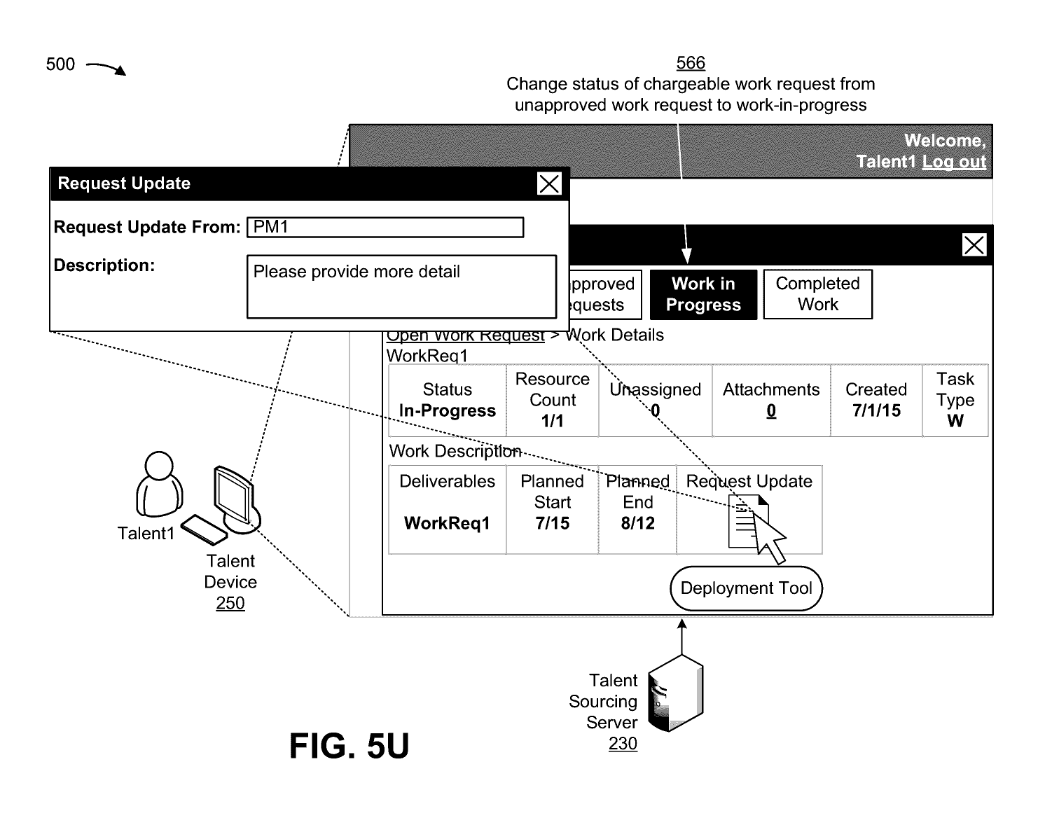

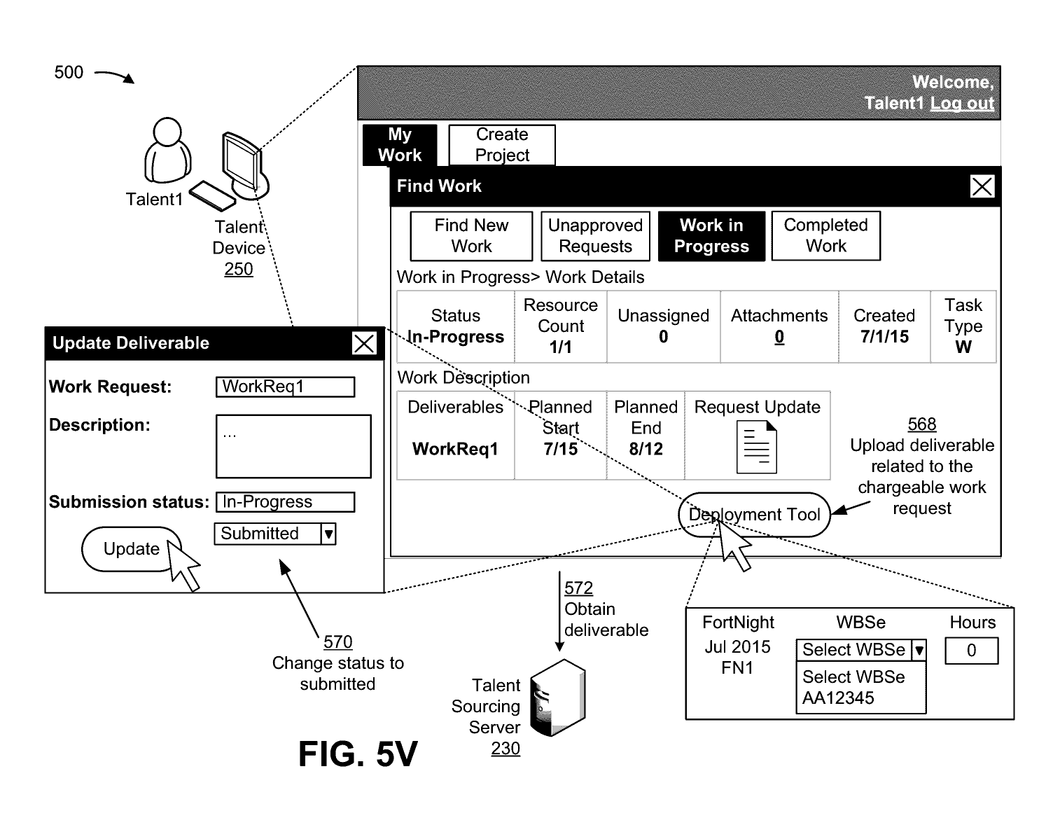

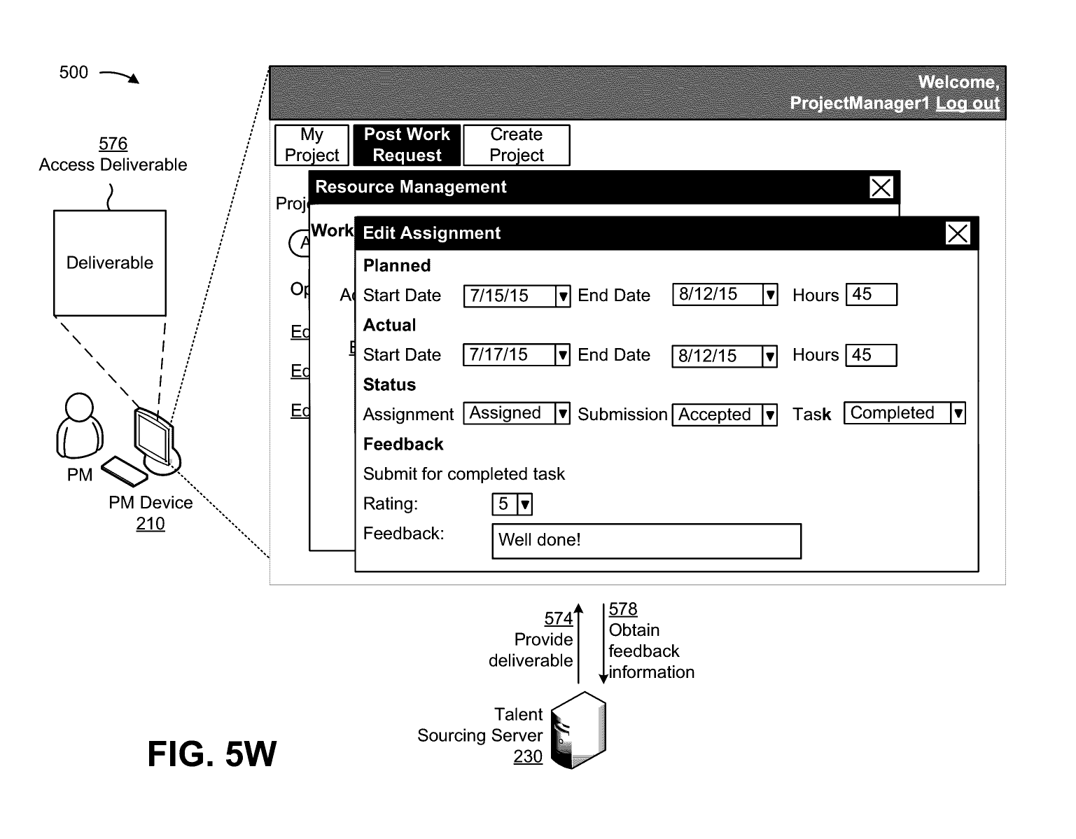

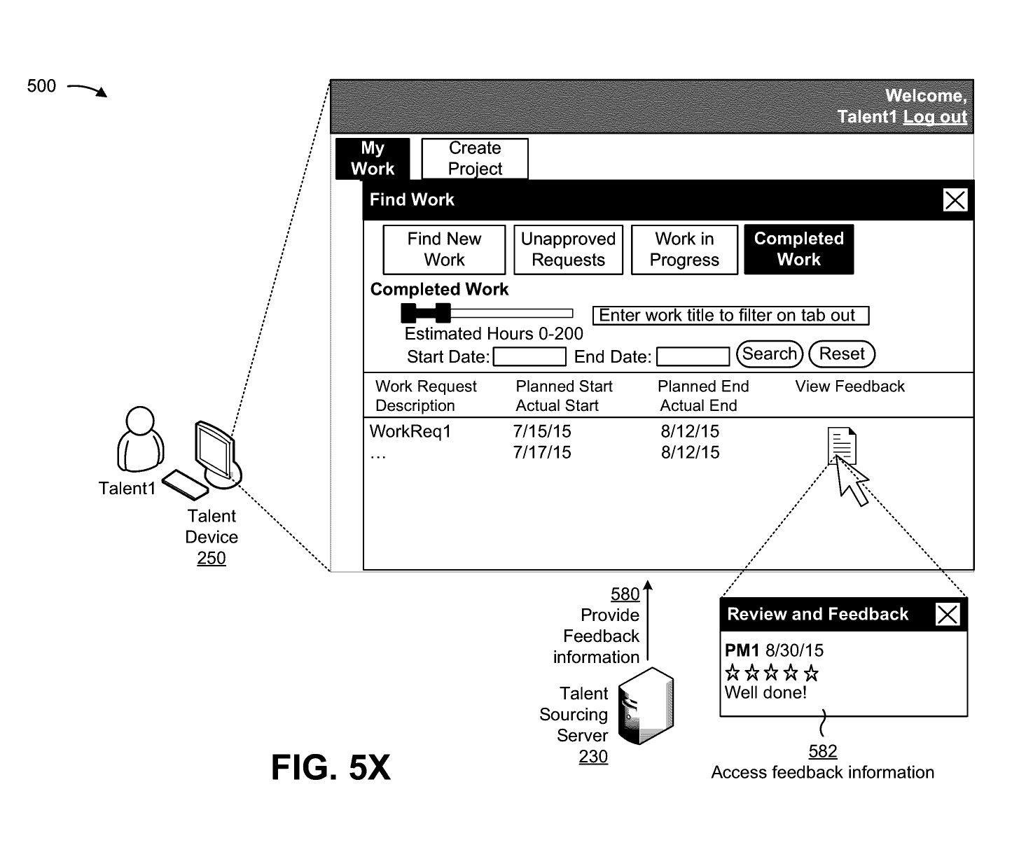

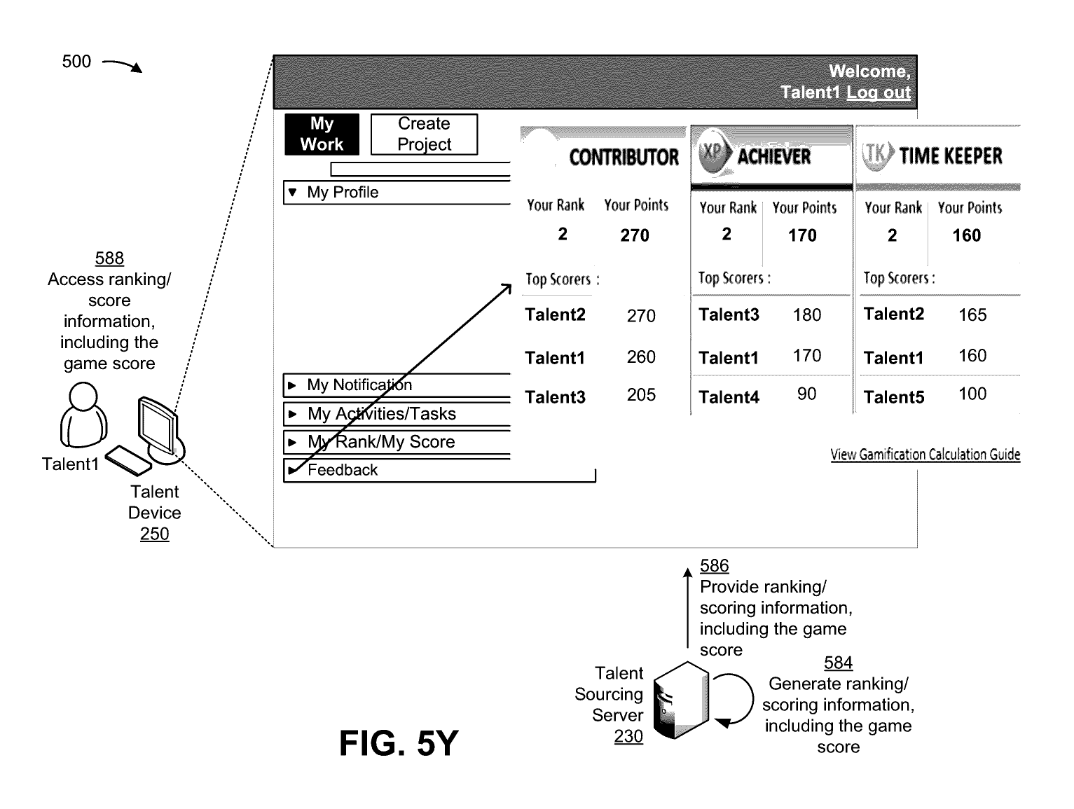

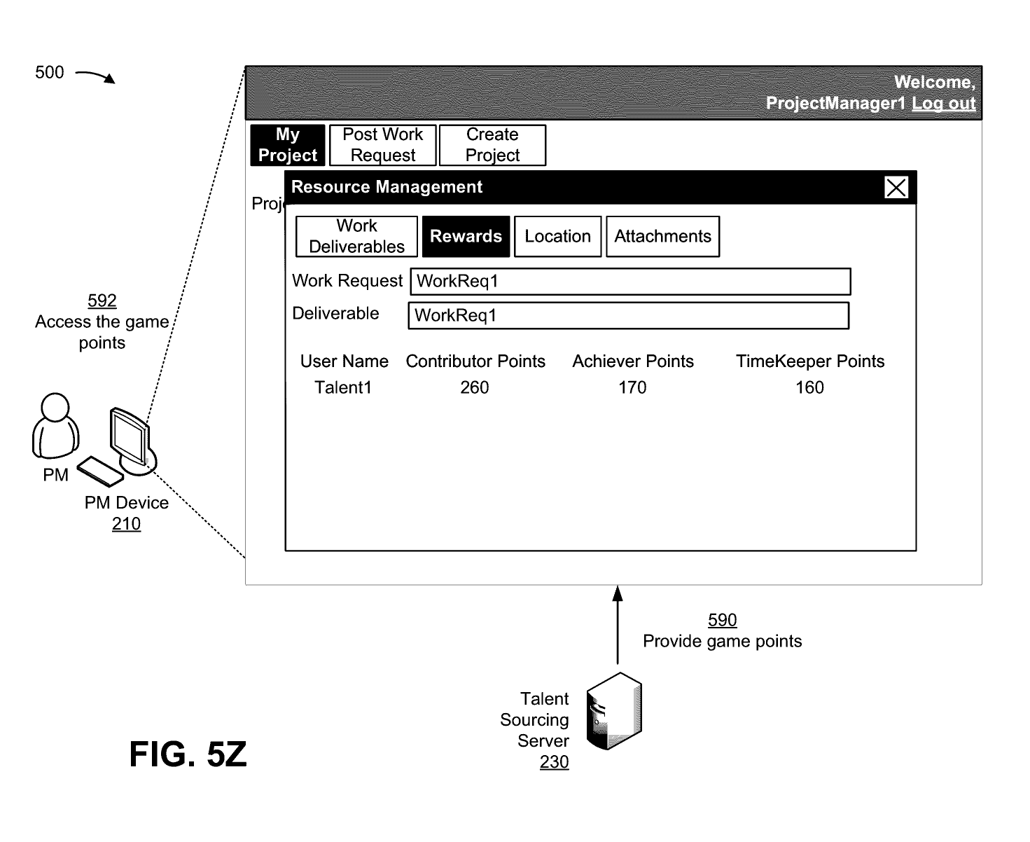

FIGS. 5A-5Z are diagrams of an example implementation 500 relating to example process 400 shown in FIG. 4. FIGS. 5A-5Z show an example of using a system for sourcing talent utilizing crowdsourcing for a chargeable work request.

As shown in FIG. 5A, assume that a user (e.g., PM) of a project manager device (e.g., PM device 210) has an account associated with a talent sourcing application, provided by the user's employer (e.g., Talent Sourcing Application, provided by a knowledge-based company). As shown in FIG. 5A, and by reference number 502, the user of PM device 210 logs into the talent sourcing application, using PM device 210, by providing credentials for log-in (e.g., a user name=ProjectManager1 and a password=‘******’). As shown in 5A, and by reference number 502, the user of PM device 210 may interact with an input mechanism (e.g., by clicking a ‘Sign in’ button) to submit the credentials from PM device 210 to talent sourcing 230 for authentication/authorization by talent sourcing server 230. As shown in 5A, and by reference number 504, talent sourcing server 230 authenticates and/or authorizes the credentials for log-in, provided by PM device 210.

As shown in 5B, and by reference number 506, a user of PM device 210 accesses a PM interface, for the talent sourcing application, to perform various actions, via talent sourcing server 230. As shown in 5B, and by reference number 508, the user of PM device 210 accesses projects and associated work requests, associated with the user of PM device 210 (e.g., access projects and associated work requests for WorkReqA, access projects and associated work requests for WorkReqB, etc.).

As shown in 5C, and by reference number 510, the user of PM device 210 accesses a project status (e.g., via a ‘Project Status’ tab on the PM interface) for the work requests associated with the user of PM device 210 (e.g., the PM has 7 work requests that are ‘Open,’ the PM has 3 work requests that are ‘In-Progress,’ the PM has 2 work requests that are ‘Completed,’ etc.).

As shown in 5D, and by reference number 512, the user of PM device 210 accesses notifications for action (e.g., via a ‘My Pending Actions/Notifications’ tab on the PM interface), from user of talent device 250, assigned to work requests associated with the user of PM device 210 and/or other users or devices. The notifications for action provide various information (e.g., an action, a name of a person requesting an action, a date, an associated work request deliverable, a description, etc.).

As shown in FIG. 5E, and by reference number 514, a user of PM device 210 accesses frequent contributor information (e.g., via a ‘Frequent Contributors’ tab on the PM interface), associated with one or more users of talent device 250, not shown, to access ranking/scoring information, associated with the one or more users of talent devices 250, for one or more game categories (e.g., Talent2 obtains a contributor game score of 270 game contributor points and Talent3 obtains a contributor game score of 205 contributor game points, where Talent1 ranks higher than Talent2, based on the contributor game score; Talent3 obtains an achiever game score of 180 achiever game points and Talent4 obtains an achiever game score of 90 achiever game points, where Talent3 ranks higher than Talent4, based on the achiever game score; Talent2 obtains a time keeper game score of 165 time keeper game points and Talent5 obtains a time keeper game score of 100 time keeper game points, where Talent2 is ranked higher than Talent5, based on time keeper game score; etc.).

As shown in FIG. 5F, and by reference number 516, a user of PM device 210 accesses feedback information (e.g., via a ‘Feedback’ tab on the PM interface) for the user of talent device 250, provided by one or more users of PM device 210 for previously, completed work requests (e.g., the PM searches for feedback information for Talent1 and obtains from a rating=5 and a comment, “Great Job!” from PM2 and a rating=4 and a comment “Works well on a team” from PM3).

As shown in FIG. 5G, and by reference number 518, the user of PM device 210 creates a work request, including associated work request information (e.g., the PM clicks on the ‘Post Work Request’ tab to create/provide a work request, including associated work request information). The user of PM device 210 provides the work request information for the work request (e.g., a work request title=‘WorkReq1,’ a task type=Chargeable, a status=Open, a planned start date=7/15/15, a planned end date=8/31/15, estimated hours=45, etc.).

As shown in FIG. 5H, and by reference number 520, the user of PM device 210 continues to create the work request by providing a list of desired skills for a user of talent device 250 (e.g., Skill 1). As shown in FIG. 5H, and by reference number 522, talent sourcing server 230 obtains the work request created and/or posted by the user of PM device 210.

As shown in FIG. 5I, assume that a user (e.g., a talent) of talent device 250 (e.g., talent device 250) has an account associated with a talent sourcing application, provided by the user's employer (e.g., Talent Sourcing Application provided by the same knowledge-based company employing PM). Assume the user of talent device 250 logs into the talent sourcing application, using talent device 250, by providing credentials for log-in (e.g., a user name and password). Assume that talent sourcing server 230 (not shown) authenticates and/or authorizes the credentials provided by talent device 250.

As shown in 5I, and by reference number 524, talent device 250 presents a talent interface for a user of talent device 250 to perform various actions, via talent sourcing server 230. As shown in 5I, and by reference number 526, talent device 250 accesses profile information (e.g., via a ‘My Profile Tab’ tab on the talent interface) and work requests (e.g., WorkReqA), associated with the user of talent device 250.

As shown in 5J, and by reference number 528, a user of talent device 250 accesses additional profile information (e.g., via a ‘My Profile Details’ link, provided under the ‘My Profile’ tab). The user of talent device 250 verifies that the profile information is accurate (e.g., verifies the profile information, including skills detail where Skill=Skill 1, is up-to-date).

As shown in FIG. 5K, and by reference number 530, the user of talent device 250 accesses notifications (e.g., via a ‘My Notification’ tab on the talent interface) from PM devices 210, provided by one or more users of PM device 210, a user of another device, and/or another device. The notifications provide various information (e.g., an action, a name of a person requesting an action, a date, an associated work request deliverable, a description, etc.) so that the user of talent device 250 may, for example, access the notifications, perform requested actions provided in the notifications, or the like.

As shown in FIG. 5L, and by reference number 532, the user of talent device 250 accesses activities/tasks (e.g., via a ‘My Activities/Tasks’ tab on the talent interface) associated with the user of talent device 250 (e.g., accesses a completion rate for work requests, associated with the user of talent device 250, accesses a types of tasks associated the work requests, etc.).

As shown in FIG. 5M, and by reference number 534, the user of talent device 250 accesses ranking/scoring information (e.g., via a ‘My Rank/My Score’ tab on the talent interface) associated with the user of talent device 250 (e.g., accesses a current rank, ‘Your Rank’=6 and a game score, ‘Your Points=0, based on combining contributor game points associated with the user of talent device 250; accesses a current rank, ‘Your Rank’=6 and a game score, ‘Your Points=0, based on combining achiever game points associated with the user of talent device 250; accesses a current rank, ‘Your Rank’=6 and a game score, ‘Your Points=0, based on combining time keeper game points associated with the user of talent device 250; etc.) and/or ranking/scoring information for other users of talent devices 250 (e.g., ranking/scoring information for other talent participating in the incentivized system for performing work associated work requests).

As shown in FIG. 5N, and by reference number 536, the user of talent device 250 accesses feedback information (e.g., via a ‘Feedback’ tab on the talent interface), associated with the user of talent device 250 (e.g., accesses feedback information provided by multiple PMs for works requests completed by Talent1, where PM 2 provided a rating=5 and a comment, “Great Job!” and PM3 provided a rating=4 and a comment “Works well on a team.”).

As shown in FIG. 5O, and by reference number 538, the user of talent device 250 searches for available work requests by entering a search criteria (e.g., searches for available work based on Talent1's skill=Skill 1 via the talent interface), using talent device 250. As shown in FIG. 5O, and by reference number 540, talent sourcing server 230 receives a request for available work requests from talent device 250, based on the search criteria provided by the user of talent device 250.

As shown in FIG. 5P, and by reference number 542, talent sourcing server 230 provides an available work request, matching the search criteria, provided by the user of talent device 250 (e.g., provides WorkReq1, created by the user of PM device 210, where the desired skill, Skills=Skill 1, matches the search criteria entered by the user of talent device 250, Skill=Skill 1). The work request provided by talent sourcing server 230 is a chargeable work request (e.g., a task type=‘W,’ where the ‘task type’ indicates a chargeable work request or WBSe).

As shown in FIG. 5P, assume the user of talent device 250 is interested in performing work on a chargeable work request, however, the user of talent device 250 requires approval from the user of PM device 210, associated with the chargeable work request. As shown in FIG. 5P, and by reference number 544, the user of talent device 250 requests assignment to the chargeable work request (e.g., the user of talent device 250 clicks the ‘Pickup’ button, to trigger a requesting assignment to WorkReq1).

As shown in FIG. 5Q, and by reference number 546, talent sourcing server 230 provides a notification to talent device 250 that the chargeable work request is pending approval (e.g., changing ‘Pickup’ button for display on the talent interface to ‘Pending Approval’). As shown in FIG. 5Q, and by reference number 548, talent sourcing server 230 adds the chargeable work request to a list of unapproved work requests (e.g., providing for display WorkReq1 under an ‘Unapproved Requests’ tab on the talent interface), for display on the talent interface.

As shown in FIG. 5R, and by reference number 550, talent sourcing server 230 provides the request for assignment from talent device 250 to PM device 210 for approval by the user of PM device 210 (e.g., PM interface displaying a notification for action, allowing Talent1 to be assigned to WorkReq1).

As shown in FIG. 5R, and by reference number 552, the user of PM device 210 interacts with an input mechanism to select the user of talent device 250 for assignment to the chargeable work request (e.g., the PM clicks on an ‘Assign’ button, associated with the chargeable work request, to trigger selection of Talent1 and/or approving Talent1's request for assignment WorkReq1). As shown in FIG. 5R, and by reference number 554, the user of PM device 210 interacts with an input mechanism, to access a talent management interface, for performing various actions related to managing the assigned chargeable work request (e.g., the PM clicks on a ‘Talent Management’ button to perform actions related to managing WorkReq1 after assignment).

As shown in FIG. 5S, and by reference number 556, the user of PM device 210 accesses the talent management interface, provided on PM device 210, to perform various actions related to managing the assigned chargeable work request. As shown in FIG. 5S, and by reference number 558, the user of PM device 210 provides a billing code (e.g., selects a billing code, where WBSe=AA12345 for the chargeable work request). As shown in FIG. 5S, and by reference number 560, the user of PM device 210 requests an update (e.g., the PM requests an update from Talent1 stating, “You have been approved for WorkReq1. Plan on providing weekly status updates.”). As shown in FIG. 5S, and by reference number 562, the user of PM device 210 provides an actual start date (e.g., PM provides an actual state date for the chargeable work request=7/17/2015, which differs from the planned start date=7/15/2015).

As shown in FIG. 5T, and by reference number 564, talent sourcing server 230 provides a notification that the request for assignment to the chargeable work request, submitted by the user of talent device 250, was approved (e.g., changing the ‘Pending Approval’ button to ‘Assigned’ for WorkReq1).

As shown in FIG. 5U, and by reference number 566, talent sourcing server 230 changes the status of the chargeable work request from an unapproved request to a work-in-progress (e.g., providing for display WorkReq1 under a ‘Work In Progress’ tab on the talent interface and permitting Talent1 to perform actions associated with WorkReq1 from the talent interface, such as sending a request for update, ‘Please provide more detail’ to PM).

As shown in FIG. 5V, assume the user of talent device 250 performs work, associated with the chargeable work request, by creating a deliverable (e.g., Talent1 creates a deliverable). Assume the user of talent device 250 charges hours for work performed to the billing code (e.g., bills time towards WBSe=AA12345) provided by talent sourcing server 230. As shown in FIG. 5V, and by reference number 568, the user of talent device 250 uploads deliverable, associated with the chargeable work request (e.g., Talent1 uploads/submits the deliverable by clicking ‘Deployment Tool’). As shown in FIG. 5V, and by reference number 570, the user of talent device 250 changes the status of the chargeable work request to submitted (e.g., Submission Status=Submitted). As shown in FIG. 5V, and by reference number 572, talent sourcing server 230 obtains the deliverables provided by talent device 250.

As shown in FIG. 5W, and by reference number 574, talent sourcing server 230 provides the deliverable to PM device 210. As shown in FIG. 5W, and by reference number 574, talent sourcing server 230 provides a notification to PM device 210 that a deliverable was provided to PM device 210 (e.g., talent sourcing server 230 providing a notification to PM device 210 that a deliverable, received from talent device 250, was provided to PM device 210). As shown in FIG. 5W, and by reference number 576, the user of PM device 210 accesses the deliverable provided to PM device 210, via the PM interface and/or another application. As shown in FIG. 5W, and by reference number 578, talent sourcing server 230 obtains feedback information provided by the user of PM device 210 to PM device 210 for the deliverable (e.g., PM provides feedback of a Rating=5 and Feedback=“Well done!” to Talent1 for work performed associated with WorkReq1), via the PM interface.

As shown in FIG. 5X, and by reference number 580, talent sourcing server 230 provides the feedback information provided by the user of PM device 210 to talent device 250. As shown in FIG. 5X, and by reference number 582, the user of talent device 250 accesses the feedback, via the talent interface (e.g., Talent1 accesses review and feedback, “Well done” and 5-stars for the rating, provided by PM1).

As shown in FIG. 5Y, and by reference number 584, talent sourcing server 230 generates ranking/scoring information, including a game score, based on the gaming information (e.g., awarding 260 contributor game points, 170 achiever game points, and 160 time keeper game points to Talent1 for completing WorkReq1, based on a Gamification Calculation guide for determining the game score).

As shown in FIG. 5Y, and by reference number 586, talent sourcing server 230 provides the ranking/scoring information, including the game score, to talent device 250. As shown in FIG. 5Y, and by reference number 588, the user of talent device 250 accesses the ranking/scoring information (e.g., accessing the score card, displaying 260 contributor game points, 170 achiever game points, and 160 time keeper game points awarded to Talent1 for completing WorkReq1 and Talent1's ranking, ‘Your Rank’=2 for all categories, as compared to other users of talent device 250, participating in the incentivized system for performing work associated with the work requests).

As shown in FIG. 5Z, and by reference number 590, talent sourcing server 230 provides to PM device 210 the game points awarded to the user of talent device 250 for completing the chargeable work request. As shown in FIG. 5Z, and by reference number 592, the user of PM device 210 accesses the game points awarded to the user of talent device 250 (e.g., the 260 contributor game points, the 170 achiever game points, and the 160 time keeper game points awarded to Talent1 for completing WorkReq1).

FIGS. 5A-5Z are provided merely as an example. Other examples are possible and may differ from what was described with regard to FIGS. 5A-5Z.

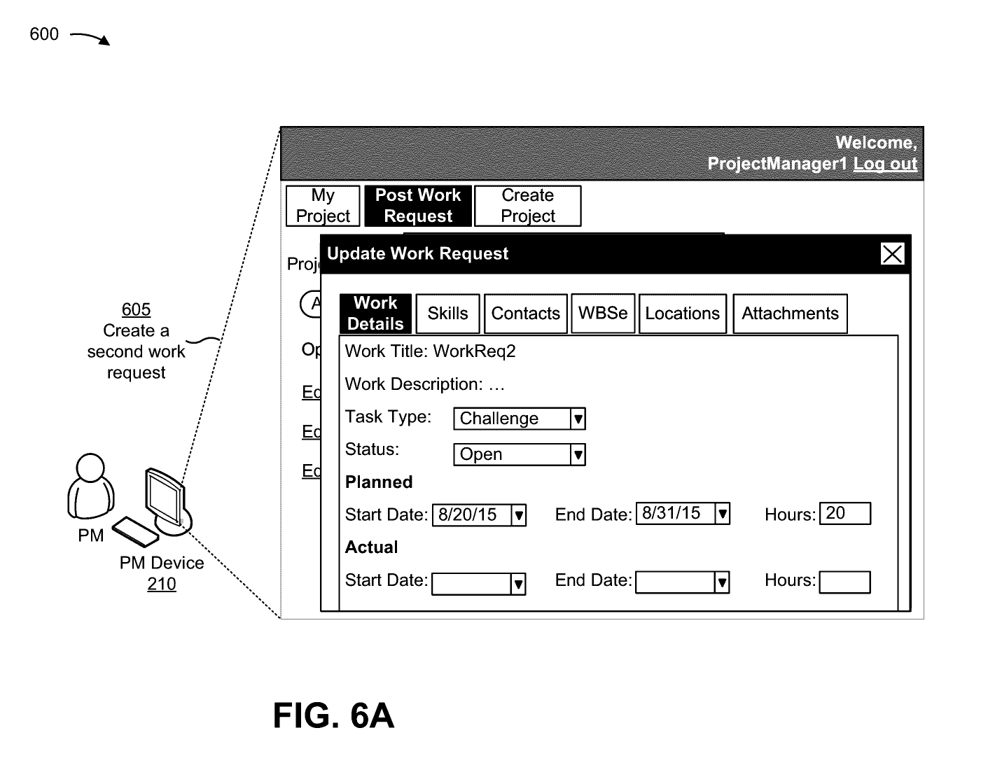

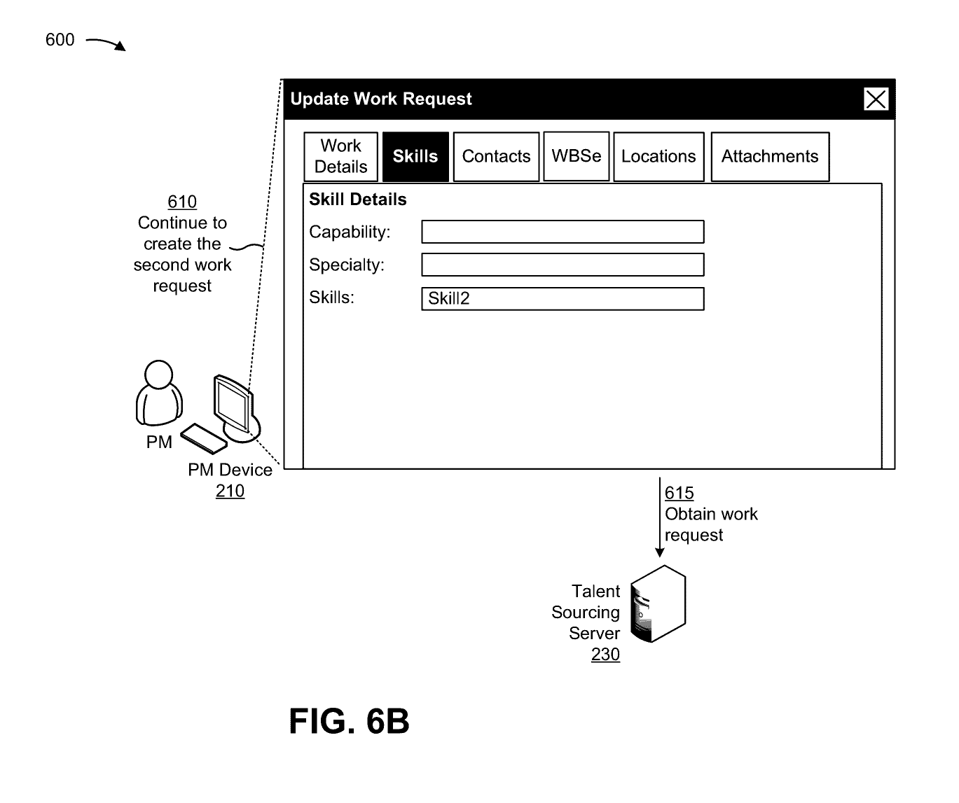

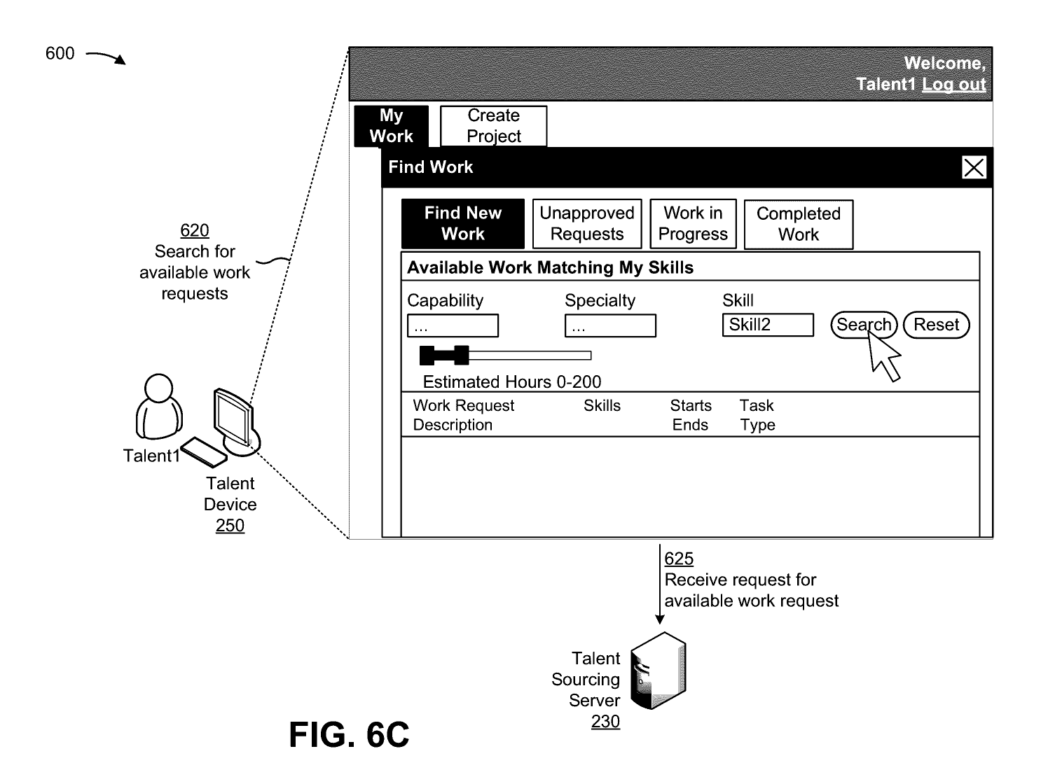

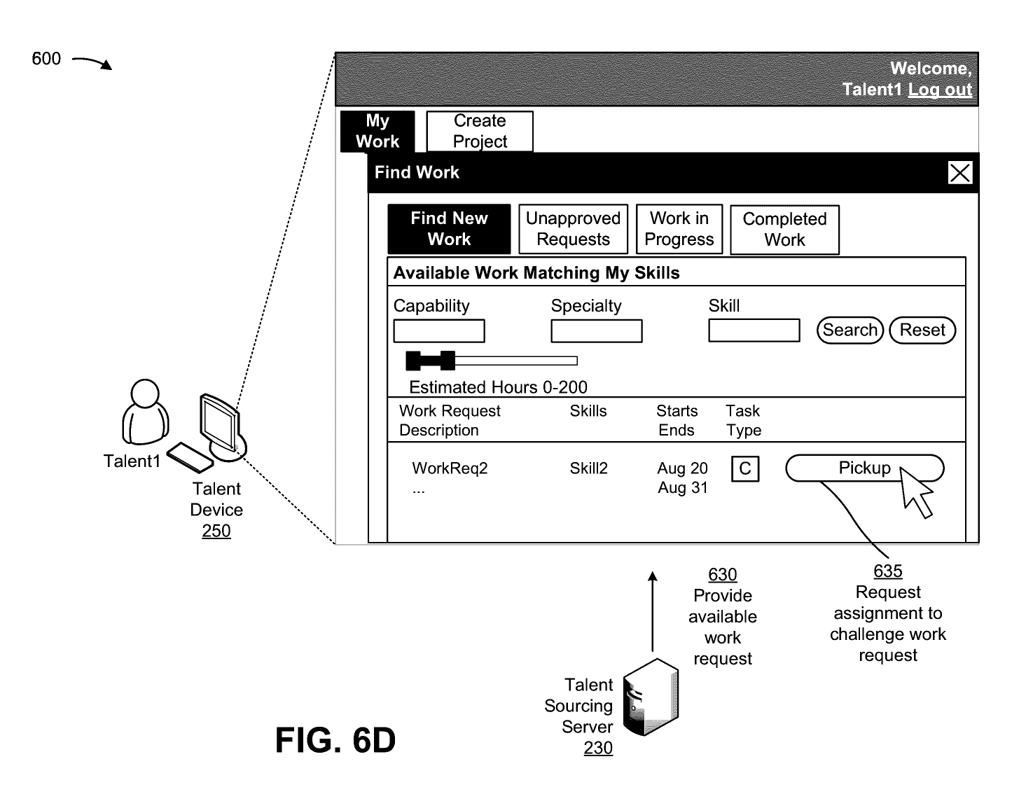

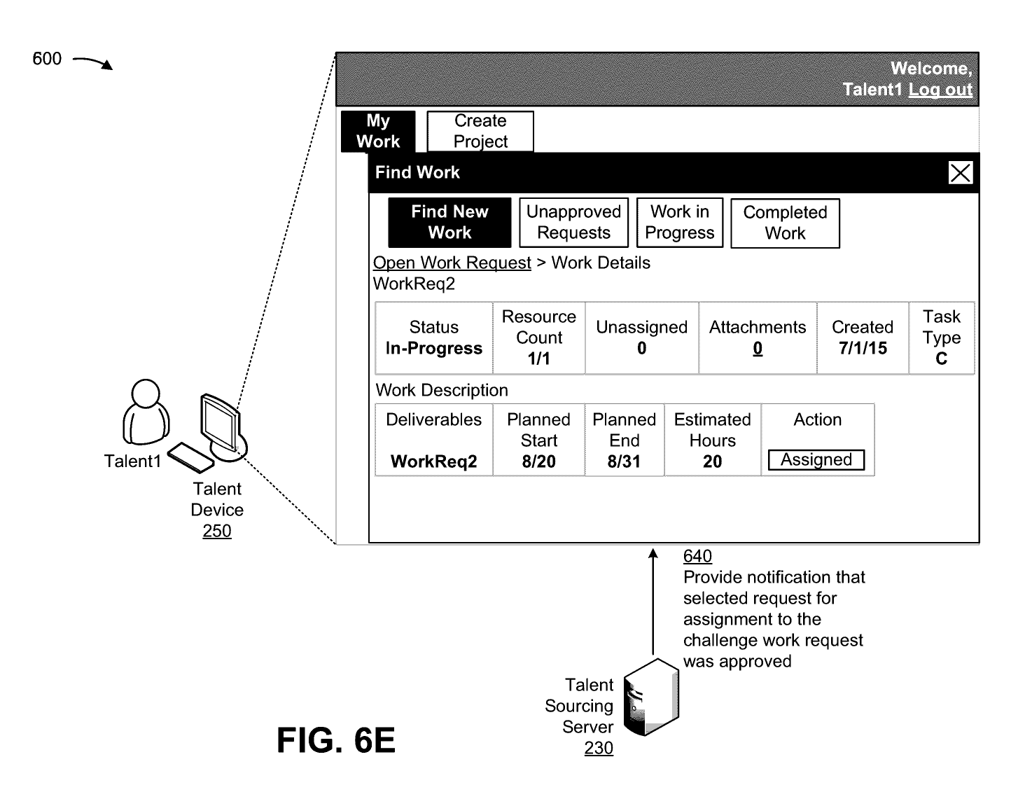

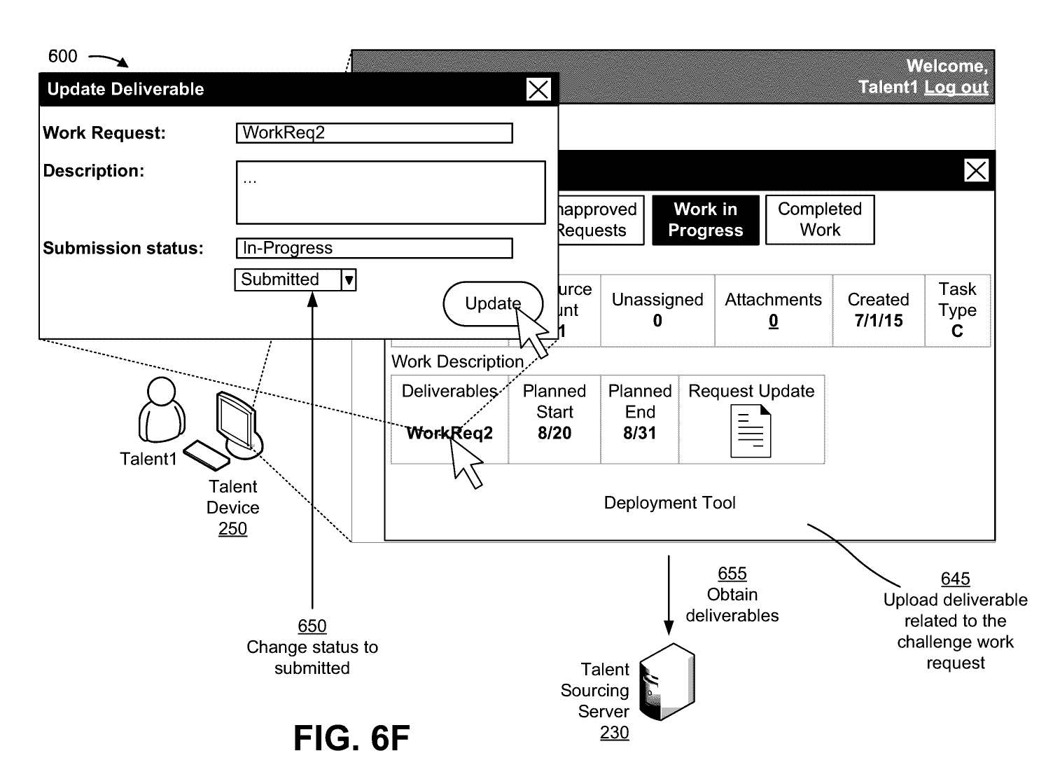

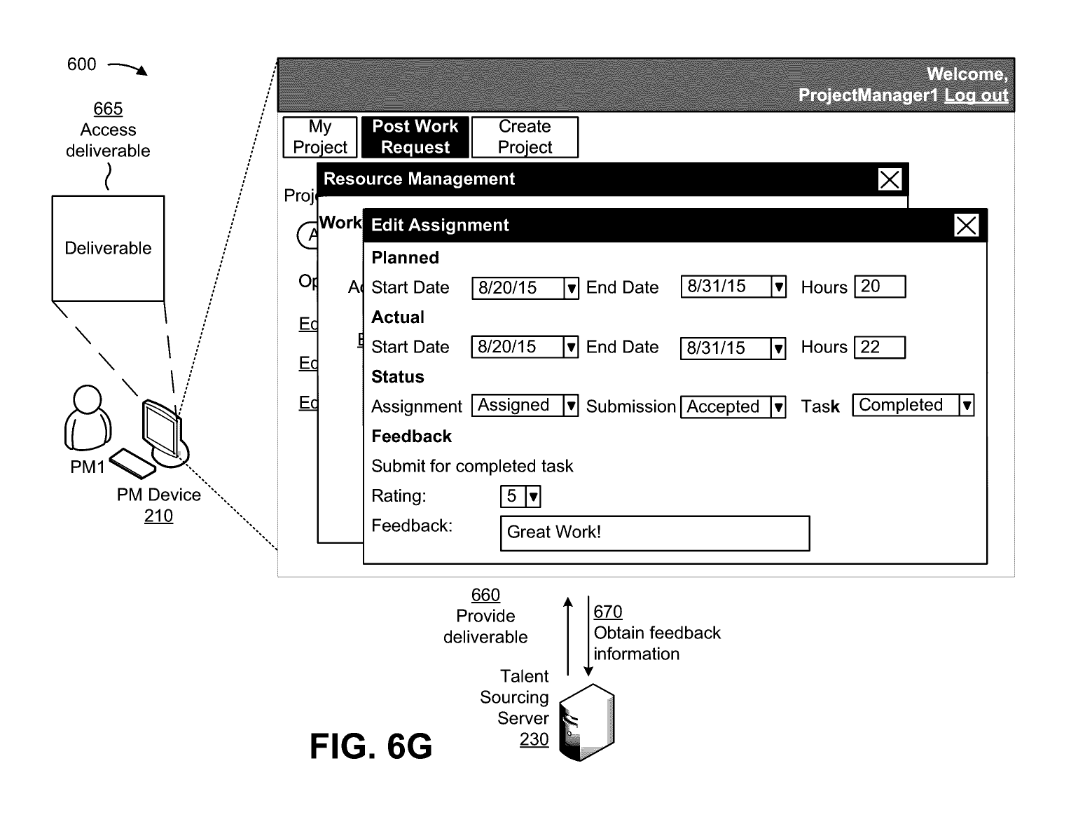

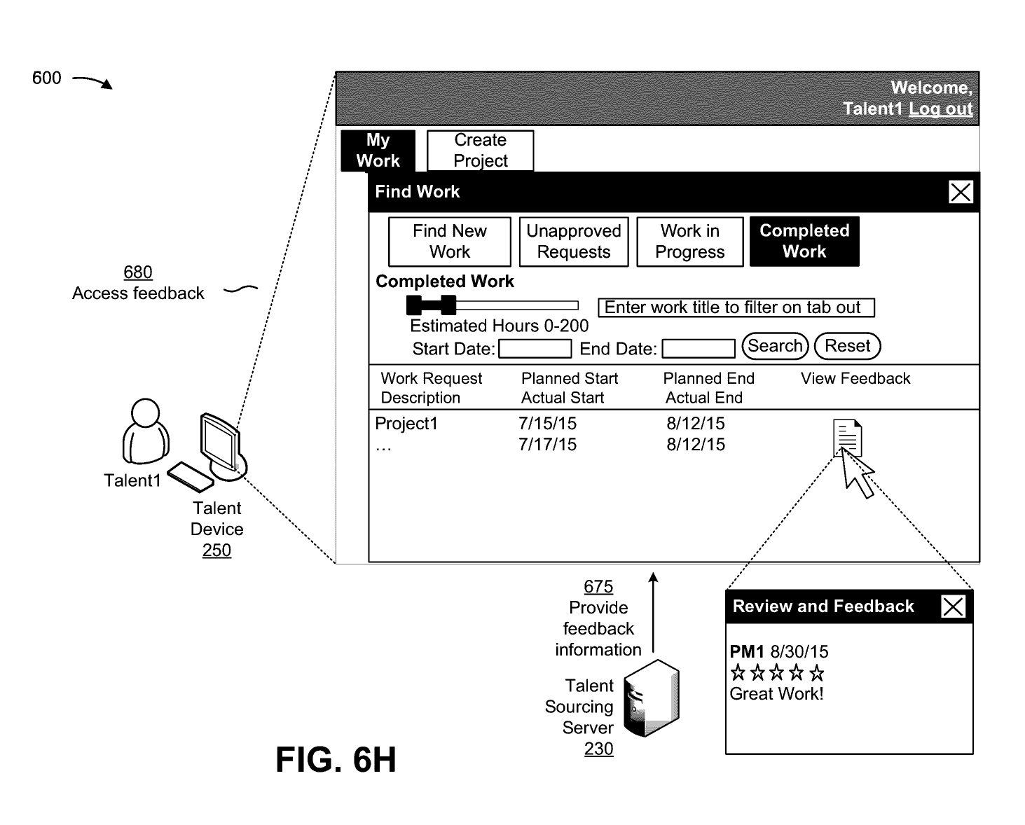

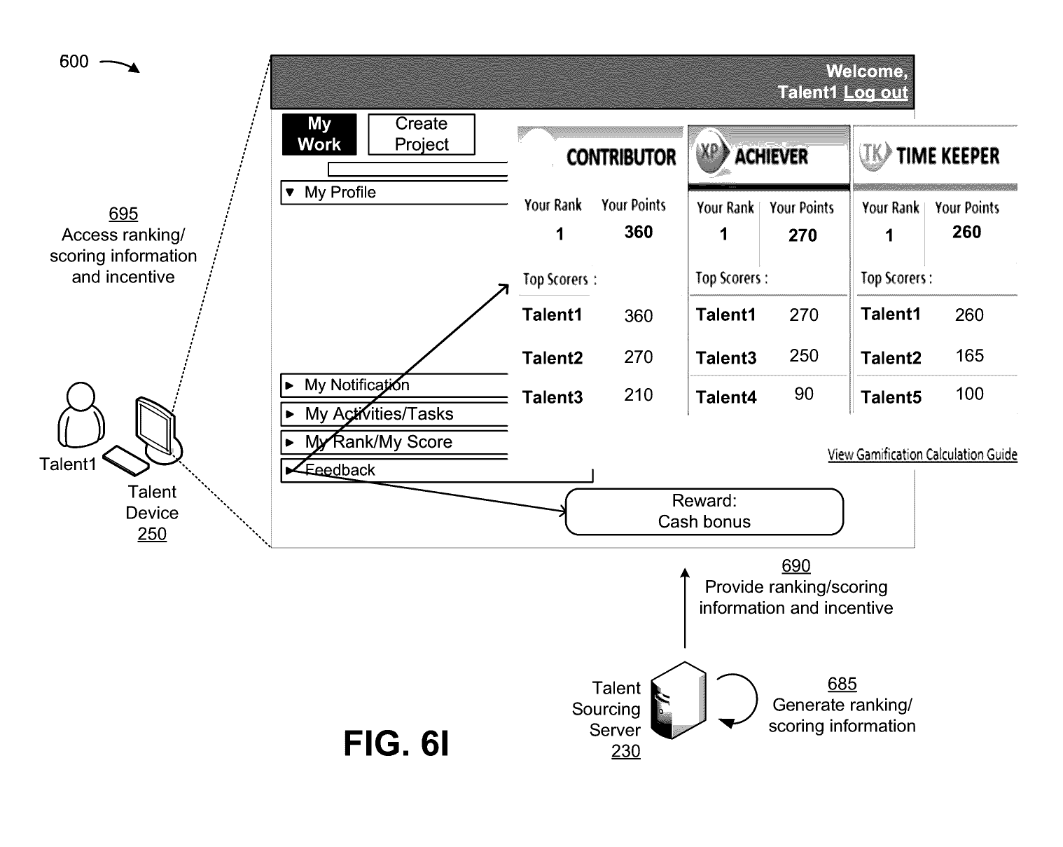

FIGS. 6A-6I are diagrams of an example implementation 500 relating to example process 400 shown in FIG. 4. FIGS. 6A-6I show an example of using a system for sourcing talent utilizing crowdsourcing for a challenge work request. Assume that the example of FIGS. 6A-6I occurs after the example of FIGS. 5A-5Z.

As shown in FIG. 6A, and by reference number 605, the user of PM device 210 creates a second work request (e.g., PM1 clicks on the ‘Post Work Request’ tab to provide work request information). The user of PM device 210 provides work request information associated with the second work request (e.g., a work request title=‘WorkReq2,’ a task type=Challenge, a status=Open, a planned start date=8/20/15, a planned end date=8/31/15, estimated hours=45, etc.).

As shown in FIG. 6B, and by reference number 610, the user of PM device 210 continues to create the second work request, by providing a list of desired skills for a user of talent device 250, to perform work associated with the work request (e.g., Skill 2). As shown in FIG. 6B, and by reference number 615, talent sourcing server 230 obtains the work request created and posted by the user of PM device 210.

As shown in FIG. 6C, assume the user of talent device 250 has updated the user's profile information, where ‘Skill’=Skill 2. As shown in FIG. 6C, and by reference number 620, the user of talent device 250 searches for available work requests by entering a second search criteria (e.g., searches for available work based on Talent1's additional skill, ‘Skill’=Skill 2, via the talent interface), using talent device 250. As shown in FIG. 6C, and by reference number 625, talent sourcing server 230 obtains a request for available work requests based on the search criteria.

As shown in FIG. 6D, and by reference number 630, talent sourcing server 230 provides available work request, based on the search criteria. As shown in FIG. 6D, and by reference number 635, the user of talent device 250 requests assignment to the challenge work request (e.g., the user of talent device 250 clicks the ‘Pickup’ button, to trigger a request for assignment to WorkReq2).

As shown in FIG. 6E, and by reference number 640, talent sourcing server 230 provides a notification to talent device 250 that the request for assignment, submitted by the user of talent device 250 for the challenge work request, was approved (e.g., changing the ‘Pickup’ button to ‘Assigned’ for WorkReq2 without requiring approval from the project manager associated with WorkReq2).

As shown in FIG. 6F, assume the user of talent device 250 performs work associated with the challenge work request by creating a deliverable, associated with the chargeable work request (e.g., Talent1 creates a deliverable). As shown in FIG. 6F, and by reference number 645, a user of talent sourcing server 230 may upload the deliverable, associated with the challenge work request, to talent device 250, via the talent interface, and/or another software application (e.g., Talent1 uploads/attaches the deliverable associated with WorkReq2, by clicking ‘Deployment Tool’). As shown in FIG. 6F, and by reference number 650, the user of talent device 250 changes the status of the challenge work request to submitted (e.g., Submission Status=Submitted). As shown in FIG. 6F, and by reference number 655, talent sourcing server 230 obtains the deliverable, associated with the challenge work request deliverable and provided by talent device 250.

As shown in FIG. 6G, and by reference number 660, talent sourcing server 230 provides the challenge work request deliverable to PM device 210. As shown in FIG. 6G, and by reference number 665, the user of PM device 210 accesses the challenge work request deliverable provided to PM device 210, via the PM interface. As shown in FIG. 6G, and by reference number 670, talent sourcing server 230 obtains feedback information, provided by the user of PM device 210 to PM device 210 for the challenge work request deliverable (e.g., the PM provides feedback of a Rating=5 and Feedback=“Great Work!” to Talent1 for work performed associated with WorkReq2), via the PM interface.

As shown in FIG. 6H, and by reference number 675, talent sourcing server 230 provides the feedback information provided by the user of PM device 210 to talent device 250. As shown in FIG. 6H, and by reference number 680, the user of talent device 250 accesses the feedback information, via the talent interface (e.g., Talent1 accesses feedback information, “Great Work” and 5-stars for the rating, provided by PM1).

As shown in FIG. 61, and by reference number 685, talent sourcing server 230 generates ranking/scoring information, including a game score based, on the gaming information (e.g., awarding 100 contributor game points, 100 achiever game points, and 100 time keeper game points to Talent1 for completing WorkReq2 based on a gamification calculation guide for determining a game score card). As shown in FIG. 6I, and by reference number 690, talent sourcing server 230 provides the ranking/scoring information to talent device 250.

As shown in FIG. 6I, and by reference number 695, the user of talent device 250 accesses ranking/scoring information (e.g., accessing the score card, displaying a contributor game score=360, by combining 260 contributor game points awarded for completing WorkReq1+100 contributor game points awarded for completing WorkReq2; accessing the score card, displaying an achiever game score=270, by combining 170 achiever game points awarded for completing WorkReq1+100 achiever game points awarded for completing WorkReq2; accessing the score card, displaying a time keeper game score=260, by combining 160 time keeper game points awarded for from completing WorkReq1+100 time keeper game points awarded for completing WorkReq2; accessing the score card, displaying Talent1's rank as ‘Your Rank’=1, as compared to other users of talent devices 250, participating in the incentivized system for performing work associated with the work requests; etc.). As shown in FIG. 6I, and by reference number 695, talent sourcing server provides incentives to the user of talent device 250, via talent device 250 (e.g., Rewards: Cash Bonus).

FIGS. 6A-6I are provided merely as an example. Other examples are possible and may differ from what was described with regard to FIGS. 6A-6I.

In this way, the PM device, the talent sourcing server, talent device, and/or another device may save processing power and resources by efficiently searching for and/or matching available and appropriate talent with available work requests based on crowdsourcing solutions.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly constructed as hardware, firmware, and/or a combination of hardware and software.

Some implementations are described herein connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

Certain user interfaces have been described herein and/or shown in the figures. A user interface may include a graphical user interface, a non-graphical user interface, a text-based user interface, etc. A user interface may provide information for display. In some implementations, a user may interact with the information, such as providing input via an input component of a device that provides the user interface for display. In some implementations, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or the methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be constructed as critical or essential unless explicitly described as such. Also, as used herein, the articles “a” and “an” are intended to include one or more items, and may be used interchangeably with “one or more.” Furthermore, as used herein, the terms “group” and “set” are intended to include one or more items (e.g., related items, unrelated items, a combination of related items and unrelated items, etc.), and may be used interchangeable with “one or more.” Where only one item is intended, the term “one” or similar language is used. Also, as used herein, the terms “has,” “have,” “having,” or the like are intended to be open ended terms. Further, the phrase “based on” is intended to mean “based, at least in part, on” unless explicitly stated otherwise.

What is claimed is:

1. A system, comprising:
one or more server devices to:
obtain a work request eligible for crowdsourcing;
determine a work request type associated with the work request;
provide the work request to a plurality of talent devices;
assign the work request to one or more users associated with the plurality of talent devices based on the work request type;
obtain one or more deliverables associated with the work request;
validate the one or more deliverables based on the work request type;
obtain feedback information for the one or more deliverables after validating the one or more deliverables;
generate a game score based on the feedback information for the one or more deliverables; and
provide the feedback information and the game score to one or more talent devices, of the plurality of talent devices, associated with the one or more users assigned to the work request.

2. The system of claim 1, where the work request type is chargeable or a challenge.

3. The system of claim 1, where the one or more server devices, when validating the one or more deliverables based on the work request type, are to:
determine whether the one or more deliverables satisfy work request requirements associated with the work request;
generate a bill based on the one or more deliverables satisfying the work request requirements; or
select one or more deliverables of the one or more deliverables, as a selected one or more deliverables, based on the selected one or more selected deliverables satisfying the work request requirements; and
provide a reward to the one or more talent devices associated with the selected one or more selected deliverables.

4. The system of claim 1, where the one or more server devices, when assigning the work request to the one or more users associated with the plurality of talent devices based on the work request type, are to:
obtain an acceptance from the one or more users, associated with the plurality of talent devices, based on the work request type being a challenge; and
automatically assign the one or more users, associated with the plurality of talent devices to the work request, providing the acceptance without input from a project management device.

5. The system of claim 1, where the one or more server devices, when assigning the work request to the one or more users associated with the plurality of talent devices based on the work request type, are to:
obtain a request for assignment from the one or more users associated with the plurality of talent devices based on the work request type being chargeable;
provide the request for assignment to a project management device for approval;
obtain approval for the request for assignment; and
assign the one or more users associated with the plurality of talent devices to the work request based on obtaining the approval for the request for assignment.

6. The system of claim 5, where the one or more server devices, when obtaining approval for the request for assignment, are to:
provide ranking/scoring information associated with the one or more users associated with the plurality of talent devices to the project management device,
the ranking/scoring information being determined based on previously completed work requests associated with the one or more users associated with the plurality of talent devices.

7. The system of claim 5, where the one or more server devices, when obtaining approval for the request for assignment, are to:
provide feedback information associated with the one or more users to the project management device,
the feedback information being determined based on previously completed work requests associated with the one or more users associated with the plurality of talent devices.

8. The system of claim 5, where the one or more server devices, when providing the request for assignment to the project management device for approval, are to:
determine a skill score for each desired skill of a plurality of desired skills for the one or more users providing the request for assignment,
the plurality of desired skills being provided in work request information associated with the work request,
the skill score being assigned a weight based on a level of importance assigned to each desired skill; and
provide a recommendation to the project management device for selecting one or more users of the one or more users, associated with the plurality of talent devices, for assigning the work request, based on the skill score.

9. A computer-readable medium storing instructions, the instructions comprising:
one or more instructions that, when executed by one or more processors, cause the one or more processors to:
obtain a work request eligible for crowdsourcing from a project management device;
determine a work request type associated with the work request,
the work request type being a first work request type or a second work request type;
provide the work request to a plurality of talent devices;
assign the work request to one or more users associated with the plurality of talent devices based on whether the work request type is the first work request type or the second work request type,
the work request being assigned after obtaining approval to assign the work request to the one or more users when the work request type is the first work request type,
the work request being automatically assigned, based on acceptance by the one or more users, when the work request type is the second work request type;
obtain one or more deliverables, associated with the work request, to provide to a project management device;
validate the one or more deliverables;
obtain feedback information for the one or more deliverables after validating the one or more deliverables; and
provide the feedback information to one or more talent devices, of the plurality of talent devices, associated with the one or more users assigned to the work request.

10. The computer-readable medium of claim 9, where the one or more instructions, that cause the one or more processors to assign the work request to the one or more users associated with the plurality of talent devices based on the work request type, cause the one or more processors to:
determine a skill score for each desired skill of a plurality of desired skills for the one or more users,
the plurality of desired skills being provided in work request information associated with the work request,
the skill score being assigned a weight based on a level of importance assigned to each desired skill; and
automatically assign the work request to the one or more users based on the skill score.

11. The computer-readable medium of claim 9, where the one or more instructions, that cause the one or more processors to determine a work request type associated with the work request, cause the one or more processors to:
compare the work request type with stored work request types;
determine the work request type to be the first work request type based on the work request type matching a stored work request type indicating the first work request type; or
determine the work request type to be the second work request type based on the work request type matching a stored work request type indicating the second work request type.

12. The computer-readable medium of claim 9, where the one or more instructions, that cause the one or more processors to determine a work request type associated with the work request, cause the one or more processors to:
automatically determine the work request type based on work request information without input from a user of the project management device.

13. The computer-readable medium of claim 9, where the one or more instructions, that cause the one or more processors to obtain a work request eligible for crowdsourcing, cause the one or more processors to:
automatically generate a work request from a project, associated with the work request, based on analyzing project requirements associated with the project; and
determine whether the work request is eligible for crowdsourcing based on analyzing the project requirements using one or more crowdsourcing guidelines.

14. The computer-readable medium of claim 13, where the one or more instructions, that cause the one or more processors to determine whether the work request is eligible for crowdsourcing, cause the one or more processors to:
determine a crowdsourcing guideline score for each of the one or more crowdsourcing guidelines based on a point value assigned to the one or more crowdsourcing guidelines,
the one or more crowdsourcing guidelines being assigned a weight based on a level of importance assigned to the one or more crowdsourcing guidelines;
combine the one or more crowdsourcing guideline scores to determine a total crowdsourcing guideline score; and
determine the work request to be eligible for crowdsourcing based on the total crowdsourcing guideline score for the work request satisfying a threshold.

15. The computer-readable medium of claim 9, where the one or more instructions, when executed by one or more processors, cause the one or more processors to:
provide ranking information for the one or more users associated with the plurality of talent devices based on a game score,
the game score being determined by combining game points awarded to each of the one or more users associated with the plurality of talent devices for completing work requests.

16. A method comprising:
obtaining, by a system that includes one or more server devices, a work request eligible for crowdsourcing from a project management device;
determining, by the system, a work request type associated with the work request;
providing, by the system, the work request to a plurality of talent devices;
assigning, by the system, the work request to one or more users associated with one or more talent devices of the plurality of talent devices based on the work request type;
obtaining, by the system and from the one or more talent devices, one or more deliverables, associated with the work request, to provide to the project management device;
validating, by the system, the one or more deliverables;
obtaining, by the system, feedback information for the one or more deliverables after validating the one or more deliverables;
generating, by the system, a game score based on the feedback information for the one or more deliverables;
providing, by the system, the feedback information and the game score to the one or more talent devices; and
providing, by the system, incentives based on the feedback information and/or the game score.

17. The method of claim 16, where assigning the work request to the one or more users comprises:
obtaining updated work request information from the project management device; and
providing the updated work request information to the one or more talent devices.

18. The method of claim 16, further comprising:
providing a communication using an on-line communication tool between the project management device and the one or more talent devices.

19. The method of claim 16, further comprising:
obtaining a billing code for work requests associated with a work request type that is chargeable; and
providing the billing code to the one or more talent devices.

20. The method of claim 16, further comprising:
providing a request for updates, associated with the work request, from the project management device to the one or more talent devices.
